(19) United States
(12) Patent Application Publication
(10) Pub. No.: US 2022/0106214 A1
(43) Pub. Date: Apr. 7, 2022

(54) METHODS AND COMPONENTS FOR PRODUCING CHILD RESISTANT GLASS CONTAINERS

(71) Applicant: CR Packaging LLC, Allston, MA (US)

(72) Inventors: Simon Knobel, Vail, CO (US); Alexander Gonzalez, Brighton, MA (US); Matthew Hayes, Boston, MA (US); Jeffrey Clark, Watertown, MA (US)

(21) Appl. No.: 17/429,304

(22) PCT Filed: Feb. 7, 2020
(86) PCT No.: PCT/US20/17242

§ 371 Date: Aug. 6, 2021

Related U.S. Application Data
(60) Provisional application No. 62/802,381, filed on Feb. 7, 2019.
(60) Provisional application No. 62/825,976, filed on Mar. 29, 2019.
(60) Provisional application No. 62/839,326, filed on Apr. 26, 2019.

(51) Int. Cl. C03B 9/32; C03B 9/197; C03B 9/34

(52) U.S. Cl. CPC C03B 9/32; C03B 9/342; C03B 9/197

(57) ABSTRACT

Disclosed herein are methods and components for manufacturing substantially square glass containers and components and a method for forming parisons are disclosed. A plunger is extended into a mold which presses molten glass against the walls of the mold and against the extended plunger. Compressed air is applied through the neck of the parison to expand the parison outwardly against another mold and an end surface defined by a baffle. The neck ring provides retention features on the neck of the glass container and can include child-resistance features. Each of the molds, neck ring, and plunger produce substantially square glass containers having a substantially square neck.

### CROSS-REFERENCE TO RELATED PATENT APPLICATION

This Application claims priority to U.S. Provisional No. 62/802,381 filed on Feb. 7, 2019, entitled, “Child Resistant Glass Container”, U.S. Provisional No. 62/825,976 filed on Mar. 29, 2019, entitled, “Child Resistant Glass Container”, and U.S. Provisional No. 62/839,326 filed on Apr. 26, 2019, titled, “Methods and Components for Producing Child Resistant Glass Containers”, the entire contents all of which are hereby incorporated by reference.

### TECHNICAL FIELD

The present disclosure relates to methods and compositions for manufacturing molded glass articles, namely glass containers including child-resistant glass containers.

### BACKGROUND

Glass container forming machines are known in the trade as the individual section or “IS” machines, used throughout the world to manufacture glass containers. IS machines are shown and described in, for example, U.S. Pat. Nos. 1,843,160, 1,911,119, and 2,289,046. IS machines produce glass containers, such as beer and beverage bottles, by the “blow and blow” process. An alternate method is used on the IS machine known as the “press and blow” process such as those described in U.S. Pat. Nos. 2,289,046 and 3,024,571.

Although glass manufacturers have for many years produced round and cylindrical shaped glass bottles (e.g., beer and beverage bottles) using the blow and blow or press and blow processes, there remains a need for a mass-produced square glass container having a substantially square-shaped neck. Also, there remains a need for a mass-produced square glass container that also provides child-resistant features.

### SUMMARY

The present disclosure relates to methods and components for manufacturing substantially square shaped glass containers. The glass containers have a substantially square container neck. The neck has one or more retention features that allow for a substantially square container cap to attach. Such features include child-resistant features. The glass manufacturing components includes a plunger, a blank mold, a neck ring, a baffle, a blow mold and other components to mass produce substantially square glass containers. The plunger is generally polygonal in shape, for example, generally or substantially square, rectangular, diamond, quadrilateral, or rhomboid in shape. The plunger, for example, has rounded corners. The blank and/or the blow molds have cavities that are also substantially polygonal. Thus, the plunger, blank mold and/or blow mold form a glass container that is generally or substantially polygonal in shape, for example, generally square, rectangular, diamond, quadrilateral, or rhomboid in shape. The neck ring and other components manufacture a glass container with features to enable the container to mate with a container cap and provide child-resistance.

Accordingly, in one aspect, a substantially square-shaped plunger is extended into a blank mold cavity, having a neck ring, which presses a gob of molten glass against walls of the blank mold cavity and against the extended plunger forming a parison. After transferring the parison to a blow mold, compressed air is applied through a neck of the parison to expand the parison outwardly against a blow mold cavity defined by the blow mold. The blank mold, neck ring, blow mold and plunger are used to manufacture glass containers that are substantially square.

In one embodiment, components used for forming a glass container includes a blank mold comprising an opening at an upper end for receiving a gob of molten glass and an opening at a lower end, wherein the blank mold defines a blank mold cavity. The components also include a plunger adjacent to the lower end the blank mold, and moveable between a retracted position out of the blank mold and an extended position in the mold cavity and a blow mold defining a blow mold cavity and configured to receive parison.

In another embodiment, the blank mold cavity, the plunger, the blow mold cavity, the neck ring, or a combination thereof is substantially square in cross-sectional shape. In some embodiments, the plunger has rounded corners. In some embodiments, the blank mold, the blow mold, the neck ring or a combination thereof, define cavities that form glass containers that are substantially polygonal in shape (e.g., substantially square). In one embodiment, the substantially polygonal container has rounded corners.

In another embodiment, components used for forming a glass container includes a neck ring comprising a first child-resistant mold on a first side and a second child-resistant mold on a second side. In one embodiment, the first child-resistant mold and the second child-resistant mold are positioned on opposite sides of the neck ring. In some embodiments, the neck ring forms one or more retention features on the neck of the parison and/or container. In some embodiments, the retention feature is formed on all sides of the container neck. In other embodiments, the retention feature is formed on one side of the container neck. The retention features allows for the container base to mate to a container cap. In some instances, the retention feature provide child-resistance.

In some embodiments, the components are configured to form a glass container having a total storage volume of 1 ml to 2000 ml. In one embodiment, the total storage volume is 2 ml to 1000 ml. In one embodiment, the total storage volume is 3 ml to 500 ml. In one embodiment, the total storage volume is 4 ml to 100 ml. In one embodiment, the total storage volume is 5 ml to 50 ml. In some embodiments, the total storage volume is about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 625, 650, 675, 700, 725, 750, 775, 800, 825, 850, 875, 900, 925, 950, 975, 1000, 1100, 1200, 1300, 1400, 1500, 1600, 1700, 1800, 1900 or 2000 ml.

Another aspect includes a component or components for forming a glass container comprising a blank mold comprising an opening at an upper end for receiving a gob of molten glass and an opening at a lower end for receiving a neck ring, wherein the blank mold defines a blank mold cavity, a plunger adjacent to the lower end the blank mold, and moveable between a retracted position out of the blank mold and an extended position in the mold cavity and a blow mold defining a blow mold cavity and configured to receive a parison.

In one embodiment, the blank mold cavity, the plunger, the blow mold cavity, or a combination thereof is substantially square in cross-sectional shape. In some embodiments, the blank mold, the plunger, the blow mold, or a combination thereof are configured to produce a substantially square shaped container. In one embodiment, the substantially square shaped container has rounded corners.

In another embodiment, neck ring is substantially square in cross-sectional shape and configured to produce a substantially square container neck. In one embodiment, the neck ring is configured to produce a retention feature on the neck of the container. In some embodiments, the retention feature is a child-resistant feature. In one embodiment, the child-resistant feature is produced on a first side of the container and a second side of the container.

In some embodiments, the component is configured to form a glass container having a storage volume of 1 ml to 2000 ml. In one embodiment, the storage volume is 4 ml to 100 ml.

In some embodiments, the component or components are part of an Individual Section machine.

Another aspect includes a method of manufacturing a glass container comprising introducing a predetermined amount of a gob of glass to a blank mold cavity defined by a blank mold, moving a substantially square-shaped plunger from a retracted position to an extended position within the blank mold cavity, forming a parison by the plunger from the predetermined amount of gob in the mold cavity, retracting the plunger out from the blank mold cavity to the retracted position, moving the parison from the blank mold to a blow mold, applying a compressed gas through a neck of the parison to expand the parison to a substantially square glass container shape defined by a blow mold and separating the substantially square glass container from the blow mold.

In one embodiment, the glass container includes a retention feature on the neck of the glass container. In some embodiments, the retention feature is a child-resistant feature. In some embodiments, the retention feature is on one or more sides of the neck of the glass container. In one embodiment, the retention feature is on opposite sides of the neck of the glass container. In one embodiment, the retention feature is on all sides of the neck of the glass container. In another embodiment, the retention feature is on another part of the container base.

In some embodiments, the glass container is manufactured at a rate of about fifty (50) to about nine hundred (900) containers per minute. In other embodiments, the glass container is manufactured at a rate of about one hundred (100) to about five hundred (500) containers per minute.

In some embodiments, the retention feature (e.g., a child-resistant feature) is formed on the neck of the parison and/or the container base.

Another aspect includes a method of manufacturing a glass container comprising introducing a predetermined amount of a gob of glass to a blank mold cavity defined by a mold, moving a plunger from a retracted position to an extended position through a neck ring and within the mold cavity, forming a substantially square glass container shape defined by the neck ring and mold, and separating the substantially square glass container having a substantially square neck from the neck ring and mold.

In some embodiments, the neck ring forms one or more retention features on the neck of the substantially square glass container. In other embodiments, each of the one or more retention features comprises a child-resistant feature.

Additional aspects of the invention will be set forth in part in the description which follows. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features and advantages of the claimed subject matter will be apparent from the following description of embodiments consistent herewith, which the description should be considered in conjunction with the accompanying drawings.

FIG. 1 illustrates an exploded view of an embodiment of a gob of glass, a mold, a neck ring and a plunger.

FIG. 2A illustrates a side perspective view of an embodiment of a gob of glass, a mold, a neck ring and a plunger.

FIG. 2B illustrates a cross-sectional view of the embodiment of the gob of glass, the mold, the neck ring and the plunger of FIG. 2A.

FIG. 3 illustrates an exploded view of an embodiment of a baffle, a partially pressed gob, a mold, a neck ring and a plunger.

FIG. 4A illustrates a side perspective view of an embodiment of a baffle, a partially pressed gob, a mold, a neck ring and a plunger.

FIG. 4B illustrates a cross-sectional view of the embodiment of the baffle, the partially pressed gob, the mold, the neck ring and the plunger of FIG. 4A.

FIG. 5 illustrates an exploded view of an embodiment of a baffle, a glass container, a mold, a neck ring and a plunger.

FIG. 6A illustrates is a side perspective view of an embodiment of a baffle, a glass container, a mold, a neck ring and a plunger.

FIG. 6B illustrates a cross-sectional view of the embodiment of the baffle, the glass container, the mold, the neck ring and the plunger of FIG. 6A.

FIG. 7A illustrates a side perspective view of an embodiment of a neck ring.

FIG. 7B illustrates another side perspective view of the embodiment of the neck ring of FIG. 7A.

FIG. 8A illustrates a side view of an embodiment of a plunger.

FIG. 8B illustrates a perspective view of the embodiment of the plunger of FIG. 8A.

FIG. 9A illustrates a side view of an embodiment of a baffle.

FIG. 9B illustrates a perspective view of the embodiment of the baffle of FIG. 9A.

FIG. 10A illustrates a side perspective view of an embodiment of a mold.

FIG. 10B illustrates another side perspective view of the embodiment of the mold of FIG. 10A.

FIG. 11A illustrates a side perspective view of an embodiment of a gob of glass, a blank mold, a neck ring and a plunger.

FIG. 11B illustrates a cross-sectional view of the embodiment of the gob of glass, the blank mold, the neck ring and the plunger of FIG. 11A.

FIG. 12 illustrates an exploded view of an embodiment of a gob of glass, a blank mold, a neck ring and a plunger.

FIG. 13A illustrates a side perspective view of an embodiment of a baffle, a partially pressed gob of glass, a blank mold, a neck ring and a plunger.

FIG. 13B illustrates a cross-sectional view of the embodiment of the baffle, the partially pressed gob of glass, the blank mold, the neck ring and the plunger of FIG. 13A.

FIG. 14 illustrates an exploded view of an embodiment of a baffle, a partially pressed gob of glass, a blank mold, a neck ring and a plunger.

FIG. 15A illustrates a side perspective view of an embodiment of a baffle, a parison, a blank mold, a neck ring and a plunger.

FIG. 15B illustrates a cross-sectional view of the embodiment of the baffle, the parison, the blank mold, the neck ring and the plunger of FIG. 15A.

FIG. 16 illustrates an exploded view of an embodiment of a baffle, a parison, a blank mold, a neck ring and a plunger.

FIG. 17A illustrates a side perspective view of an embodiment of a parison, a neck ring, a blow mold and a bottom plate.

FIG. 17B illustrates a cross-sectional view of the embodiment of the parison, the neck ring, the blow mold and the bottom plate of FIG. 17A.

FIG. 18 illustrates an exploded view of an embodiment of a parison, a neck ring, a blow mold and a bottom plate.

FIG. 19A illustrates a side perspective view of an embodiment of a blow mold, a parison and a bottom plate.

FIG. 19B illustrates a cross-sectional view of the embodiment of the blow mold, the parison and the bottom plate of FIG. 19A.

FIG. 20 illustrates an exploded view of an embodiment of a blow mold, a parison and a bottom plate.

FIG. 21A illustrates a side perspective view of an embodiment of a blow mold, a blow head, a blow tube, a glass container and a bottom plate.

FIG. 21B illustrates a cross-sectional view of the embodiment of the blow mold, the blow head, the blow tube, the glass container and the bottom plate of FIG. 21A.

FIG. 22 illustrates an exploded view of a blow mold, a blow head, a blow tube, a glass container and a bottom plate.

FIG. 23A illustrates a bottom perspective view of an embodiment of a blank mold.

FIG. 23B illustrates a side perspective view of the embodiment of the blank mold of FIG. 23A.

FIG. 24A illustrates a side perspective view of an embodiment of a blow mold.

FIG. 24B illustrates another side perspective view of the embodiment of the blow mold of FIG. 24A.

FIG. 25A illustrates a side perspective view of an embodiment of a neck ring.

FIG. 25B illustrates another side perspective view of the embodiment of the neck ring of FIG. 25A.

FIG. 26A illustrates a side view of an embodiment of a plunger.

FIG. 26B illustrates a perspective view of the embodiment of the plunger of FIG. 26A.

FIG. 27A illustrates a side view of an embodiment of a baffle.

FIG. 27B illustrates a perspective view of the embodiment of the baffle of FIG. 26B.

FIG. 28A illustrates a side perspective view of an embodiment of a blow head.

FIG. 28B illustrates another side perspective view of the embodiment of the blow head of FIG. 28A.

FIG. 29A illustrates a top view of an embodiment of a bottom plate.

FIG. 29B illustrates a perspective view of the embodiment of the bottom plate of FIG. 29A.

FIG. 30A illustrates a top perspective view of an embodiment of a glass container.

FIG. 30B illustrates a bottom perspective view of the embodiment of the glass container of FIG. 30A.

FIG. 30C illustrates a side view of the embodiment of the glass container of FIG. 30A.

FIG. 30D illustrates a cross-sectional view (Section M-M) of the embodiment of the glass container of FIG. 30C.

FIG. 31 (includes a top view in FIG. 31A and an above view in FIG. 31B) depicts a preferred glass container base unit.

FIG. 32 depicts an exemplary cap unit that can mate with a container base.

### DETAILED DESCRIPTION

The present disclosure relates to components and methods of producing glass containers. Other aspects of the present disclosure include components and methods for producing features on the glass containers to provide or enable child-resistance (e.g., for creating child-resistance and for storing or holding a material). The components and methods can be understood more readily by reference to the following detailed description of the disclosure. It will be apparent to those skilled in the art that various modifications can be made without departing from the scope of the invention.

As used in the specification and the appended claims, the singular forms “a,” “an” and “the” include plural referents unless the context clearly dictates otherwise. Thus, for example, reference to “an element” includes two or more elements.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of aspects described in the specification.

It is understood that the glass manufacturing components, machines, and materials disclosed herein have certain functions. Disclosed herein are certain structural requirements for performing the disclosed functions, and it is understood that there are a variety of structures that can perform the same function that are related to the disclosed structures, and that these structures will typically achieve the same result.

The components and methods described herein are part of the glass manufacturing process. Embodiments of the glass containers produced through these processes have retention features on the container neck. Embodiments of the retention features include child-resistant features. Embodiments of the glass containers produced through these processes are also modular (e.g., stackable). Embodiments of the glass containers produced through these processes are also generally square in shape. The disclosed glass containers provide improved packaging and storage of substances or materials in a controlled environment, providing, for example, an air-tight, liquid-tight, water-tight, humidity-controlled, light-controlled, static-free or any combination thereof, environment. A variety of materials, such as glass (e.g., any non-crystalline, amorphous solid) and other glass-like materials (e.g., porcelain, thermoplastics) are used in this process.

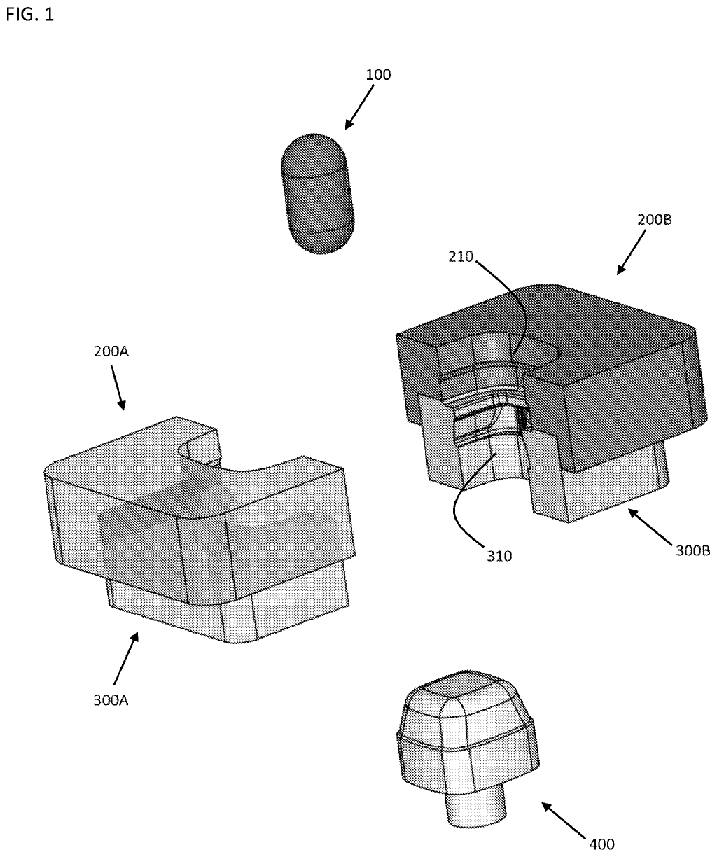

There are two primary methods of making and mass-producing glass containers: “blow and blow” and “press and blow.” In some instances, the components and methods described herein relate to the “press and blow” process of glass manufacturing. Glass is also manufactured in a single step, e.g. “press” only or “blow” only. In any of these methods, molten glass from a furnace enters a feeder, where it gets pushed down through a tube. As the glass emerges from the tube, it is cut to form a lump of glass, called a gob (e.g., gob 100 in FIG. 1). The gob has a predetermined size and weight sufficient to make and be formed into a container.

Both the “blow and blow” and “press and blow” processes include a “blank side” in which the gob is formed into a partially completed form known as a parison, and a “blow side” where the final shape of the container is achieved. The container starts off upside down and is gripped by a “neck ring” which allows the parison to be inverted as it moves from the blank side to the blow side.

In a “press” or “blow” only manufacturing process, the gob is formed into a completed form all in a single step. No additional step (e.g., an additional blow step) is necessary to achieve the desired final shape of the glass container.

In the press and blow process, a gob is guided into a blank mold, two halves of which are clamped shut and then sealed by a baffle at the open top end of the blank molds. The gob is formed into a parison by a plunger, for example, plunger 100 of FIG. 1, which presses the molten glass out to fill the blank mold and baffle. The baffle is then removed, the blank mold opened, and the inverted parison is transferred to an upright position by neck rings where it is enclosed within a blow mold by closing two blow mold halves. The parison is then blown out (e.g., by compressed air) into the blow mold to form the final shape of the glass container.

In the blow and blow process, compressed air is used to form the gob into a parison, which establishes the neck finish and gives the gob a uniform shape. From there the parison is transferred to the blow mold where compressed air is used to blow the bottle into its final shape.

The I.S. Machine or “Individual Section Machine” is designed to ensure efficient production of glass containers, so that operators can take one or more sections out of production for repairs without shutting down production in other sections. One or more gobs enter the I.S. Machine and are formed into containers through a process of controlled shaping and cooling of the glass.

The total time need to produce a container is about 10 containers per minutes to about 1000 containers per minute. Factors that determine production rate include the machinery and the container's size and shape. The production speed may about 10, 25, 50, 75, 100, 125, 150, 175, 200, 225, 250, 300, 350, 400, 450, 500, 600, 700, 800, 900, 1000 or more containers per minute.

In some aspects, the container is produced at a rate of about 10 to about 1000 per minute. In some aspects, the container is produced at a rate of about 50 to about 900 per minute. In some aspects, the container is produced at a rate of about 100 to about 500 per minute. In some aspects, the container is produced at a rate of about 100 to about 250 per minute.

In some aspects, the container is produced at a rate of about 10 or more per minute. In some aspects, the container is produced at a rate of about 25 or more per minute. In some aspects, the container is produced at a rate of about 50 or more per minute. In some aspects, the container is produced at a rate of about 75 or more per minute. In some aspects, the container is produced at a rate of about 100 or more per minute. In some aspects, the container is produced at a rate about 200 or more per minute. In some aspects, the container is produced at a rate of about 300 or more per minute. In some aspects, the container is produced at a rate of about 400 or more per minute. In some aspects, the container is produced at a rate of about 500 or more per minute. In some aspects, the container is produced at a rate of about 600 or more per minute. In some aspects, the container is produced at a rate of about 700 or more per minute. In some aspects, the container is produced at a rate of about 800 or more per minute. In some aspects, the container is produced at a rate of about 900 or more per minute. In some aspects, the container is produced at a rate of about 1000 or more per minute.

Depending on the size, shape, and other variables of the glass container being manufactured, the glass container is formed in a one-step process or a two-step process (e.g., press and blow or blow and blow). For example, smaller sized glass containers are formed in a single process where a gob of glass is pressed to the desired shape of the final container. Larger sized glass containers may require an additional step, where the intermediate parison formed by pressing is then blown to its desired shape.

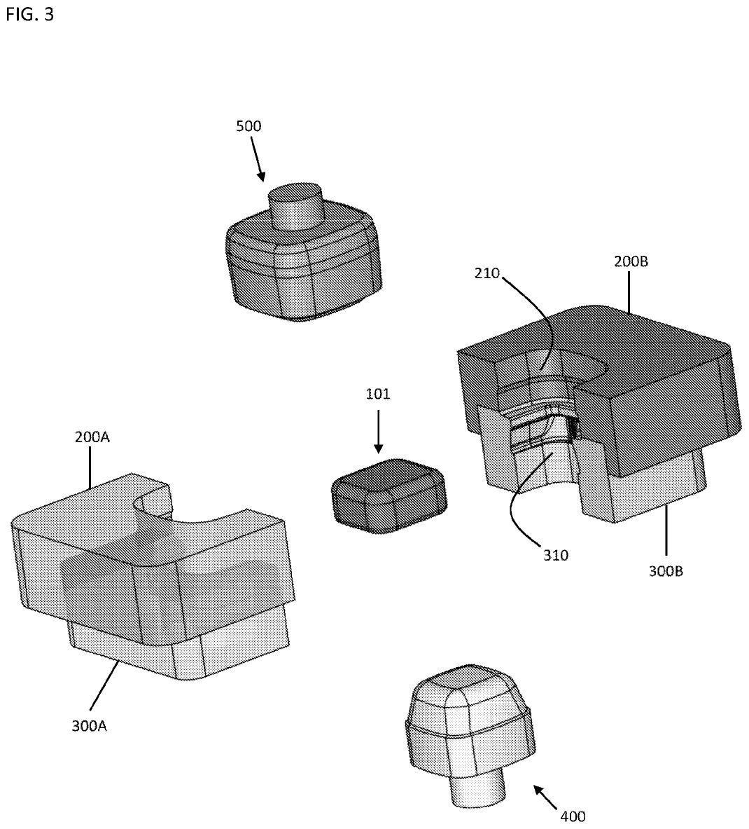

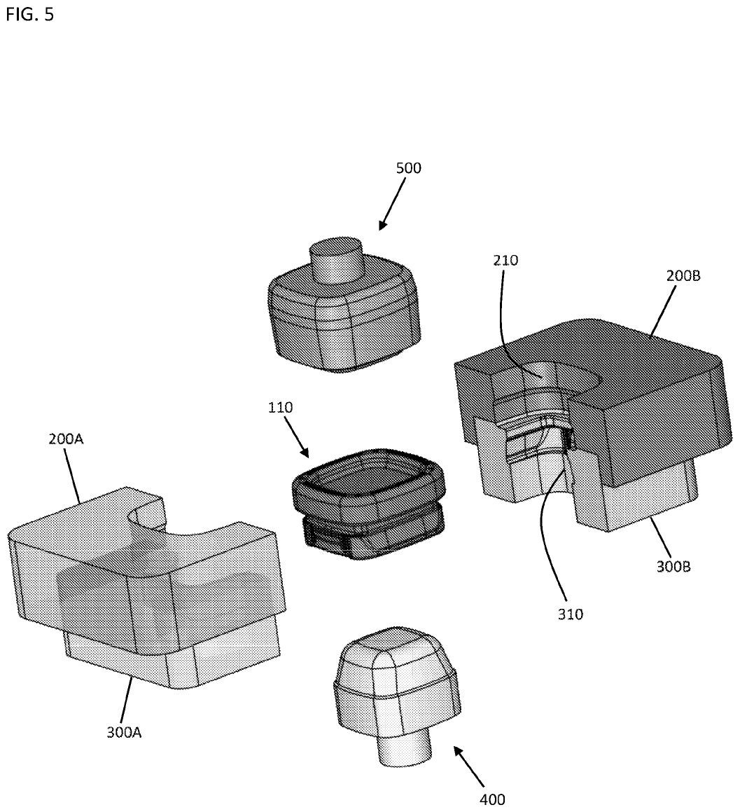

Referring to FIGS. 1-10B, a single press stage manufacturing process is illustrated along with various components of an IS Machine or glass manufacturing machine. A gob of glass 100 is guided and fed into mold cavity 210, defined by a mold 200 having halves 200A and 200B, and neck ring cavity 310, defined by a neck ring 300. At a bottom end, a plunger 400 is moveable between a retracted position to an extended position. In a retracted position, plunger 400 is withdrawn from blank mold 200 and/or neck ring 300. This allows for gob 100 to load into mold cavity 210. In an extended position, plunger 400 is moveable through neck ring 300 and mold 200.

Gob of glass 100 has a predetermined mass, shape, or both. Gob 100 is a discrete slug of glass sheared from a molten glass stream and matching the desired container weight. Gob 100 is comprised of any glass (e.g., any non-crystalline, amorphous solid), any glass-like material (e.g., porcelain, thermoplastics), polymer glass, glass-ceramic, ceramic material, or combination thereof. For example, the glass can be an amber glass, a green glass, an opal glass, a transparent glass, recycled glass, flint glass, tempered glass, soda-lime glass, borosilicate glass, or others.

Mold 200 is made up of two halves 200A, 200B. Mold 200 defines mold cavity 210, sized and configured to receive gob of glass 100 and plunger 400 to move from a retracted position to an extended position. Mold 200 is shaped and designed to produce a substantially square shaped container. The container has a substantially square or rectangular cross-sectional shape. In particular, mold 200 forms the desired shape of the container body.

Neck ring 300 is made up of two halves 300A, 300B. Neck ring 300 is sized and configured to sit directly beneath and align with mold 200. Neck ring 300 defines neck ring cavity 310, sized and configured to receive gob of glass 100 and plunger 400 to move from a retracted position to an extended position. Neck ring 300 is shaped and designed to produce a container neck having a substantially square or rectangular cross-sectional shape. Also, neck ring 300 is shaped and designed to produce one or more retention features on a container neck. In some embodiments, one or more child-resistant retention features are formed on the container neck. Such features are described herein and include child-resistant features to securely mate a container cap with the container neck. Alternatively, other retention features that allow a container cap to attach to or be placed on a container, such as the neck, can be produced on the container neck.

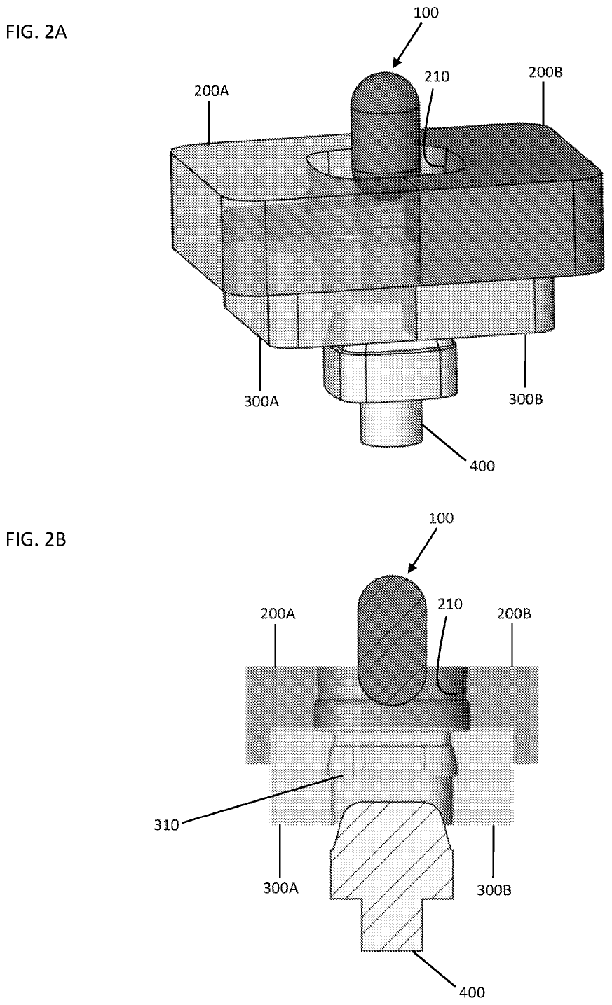

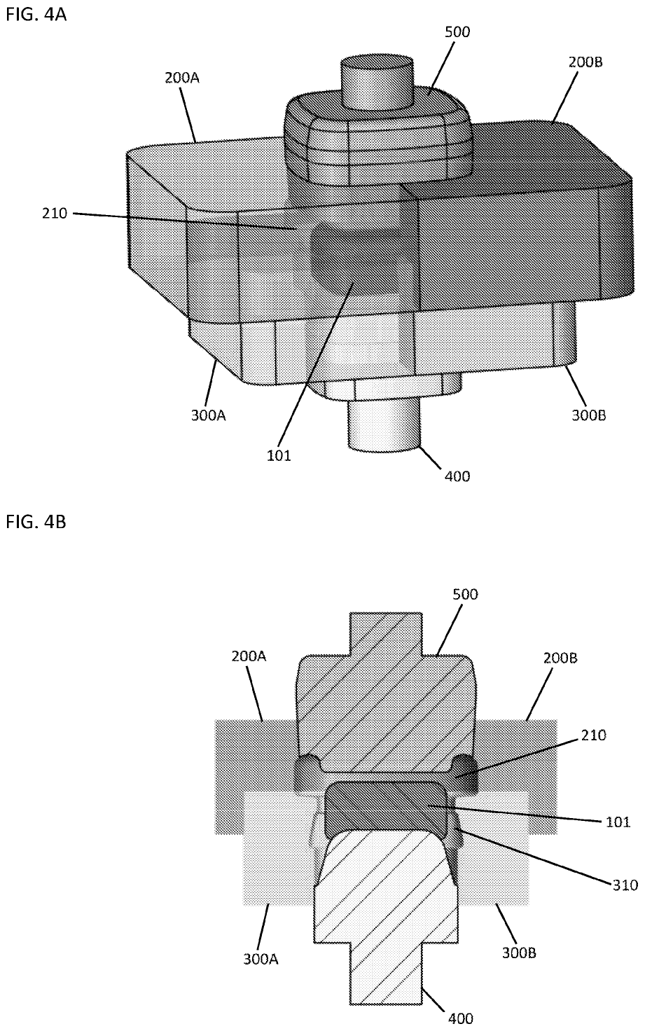

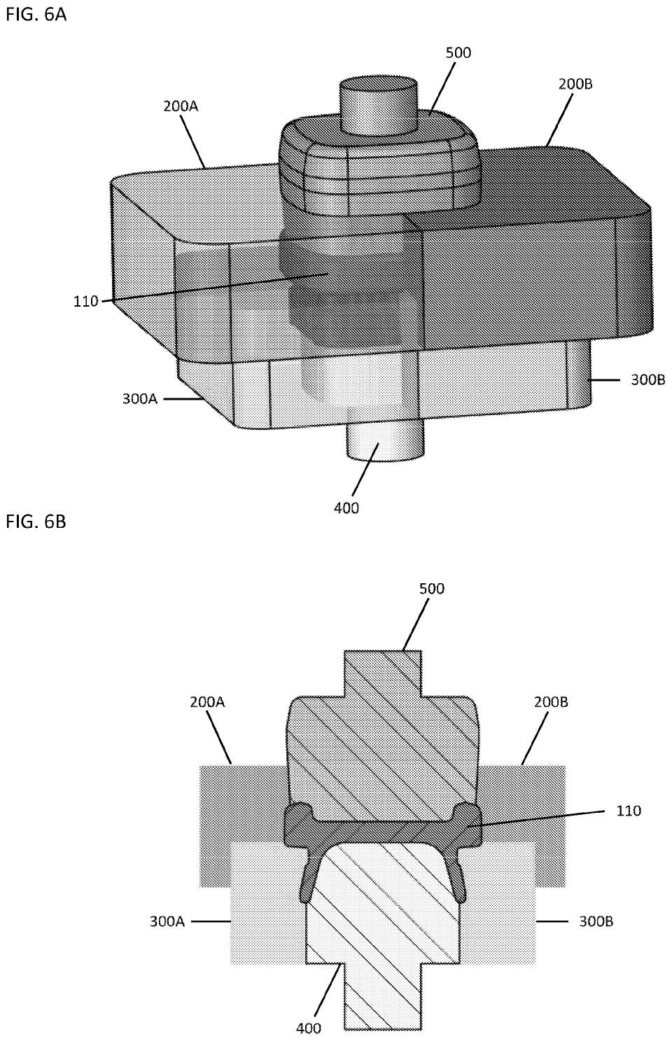

Referring to FIGS. 1-2, gob of glass 100 loads into mold cavity 210 defined by mold 200. Mold halves 200A, 200B are clamped shut and sealed by baffle 500 at the open top end of mold 200. Once gob 100 is loaded, plunger 400 starts to move up from the open bottom end of neck ring 300. Plunger 400 moves from a retracted position to an extended position. Movement of plunger 400 presses and displaces gob of glass 100 outwardly to fill mold 200, baffle 500, and neck ring 300 (See FIGS. 4A and 4B). Gob of glass 101 (FIG. 4A, 4B) substantially conforms to the shape of the cavity defined by mold 200, neck ring 300 and baffle 500 caused from movement of plunger 400. Plunger 400 continues to move to an extended position and presses glass 101 to form glass container 110 (FIGS. 6A, 6B).

The size and shape of the glass manufacturing components (e.g., the baffle, the mold, the neck ring and the plunger) defines the desired glass container. Generally, substantially square-shaped containers are manufactured using the components described herein. Also, any polygonal-shaped container may be manufactured as described herein. The container, for example, may be generally square, rectangular, diamond, quadrilateral, or rhomboid in shape. In some aspects, the container is substantially square, square, and/or square with rounded edges. The sides of the container may be planar or substantially planar such that they are slightly concave or convex. Thus, the glass manufacturing components described herein have such geometries to allow for production of polygon-shaped containers.

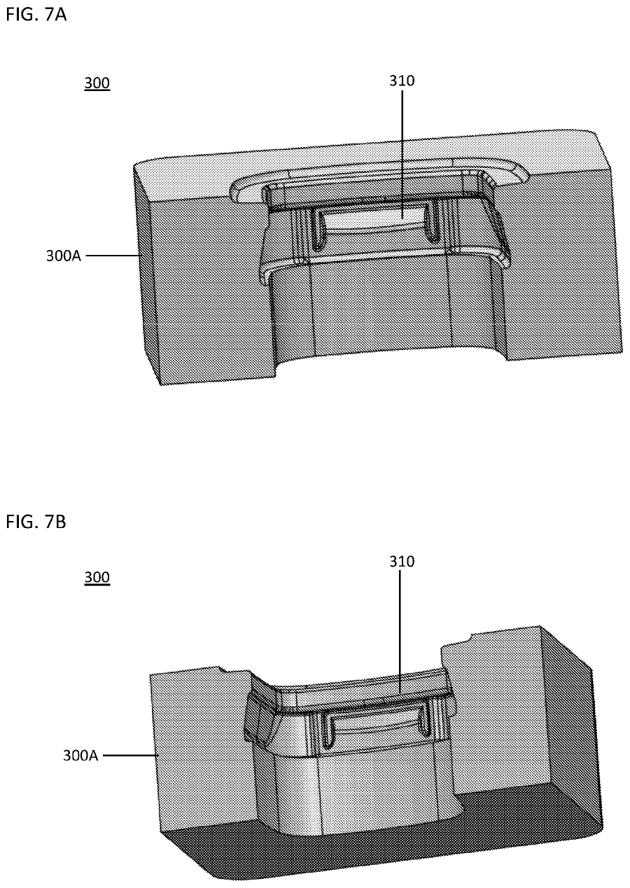

Referring to FIG. 7A and 7B, neck ring 300 has halves 300A and 300B that form and define neck ring cavity 310. In certain aspects, neck ring cavity 310 defines a mold to form one or more child-resistant features on the glass container (i.e., the neck of the glass container) during the manufacturing process. Such child-resistant features are described and illustrated herein. In one embodiment, a child-resistant feature is formed on opposites sides of the glass container. In another embodiment, a child-resistant feature is formed on one, two, three, or more sides of the neck of a glass container. The child-resistant feature includes a mechanism on the base for a container cap to mate with the container base providing a child-resistant container. In other aspects, neck ring cavity defines a mold to form a cap retention feature, such as threading, rails, rims, ledges, and the like.

Child-resistance relates to the engagement of the container base with the container cap to deter and/or prevent children from gaining access to the inside of the container. As shown and described herein, one or more cap engagement mechanisms are part of the container base and can be found on the neck of the container base. A cap engagement mechanism is made up of a pair of ramps and a ridge. The cap engagement mechanism is in a “U” or “H” shape or another configuration. The ramps extend from at or near the open end of a cap to or near the transfer neck or foot/support portion of the container base. A ridge is formed between two ramps. The ramps and ridge provide guidance and alignment of the container cap in addition to providing a tight fit with the container base. The cap engagement mechanism prevents a container cap from easily being taken off the container base or removed improperly. Generally, a cap engagement mechanism is position on two, opposite sides of the container base. However, other configurations of the cap engagement mechanisms are contemplated, such as 1, 3 or 4 mechanisms on the container base.

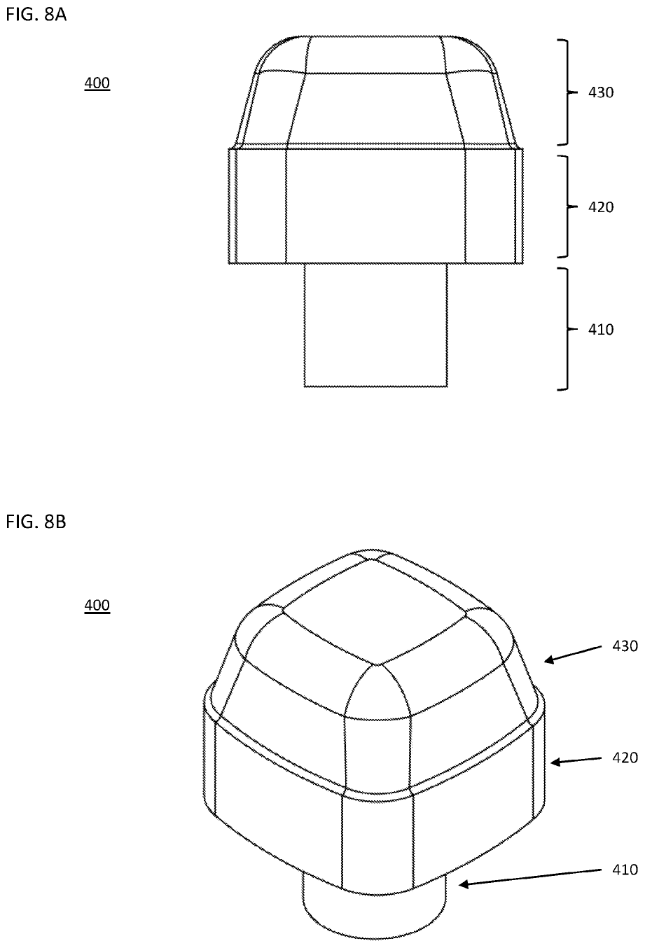

Referring to FIGS. 8A and 8B, plunger 400 has shaft 410, lower portion 420 and upper portion 430. Upper portion 430 is shaped and sized to press molten glass out to fill the blank mold, baffle and neck ring. Plunger 400 presses the glass to substantially form a cavity of the container base (e.g., container 110). Lower portion 420 has a substantially rectangular cross-sectional shape and is generally square with rounded corners in shape. Lower portion 420 extends to upper portion 430. Upper portion 430 slightly tapers to a terminal end of plunger 400. The cavity of the container base formed by plunger 400 substantially correlates to the volume of upper portion 430. Substantially square geometries are produced by the components and methods described herein, but also polyhedron, prism and other related three-dimensional geometries are produced.

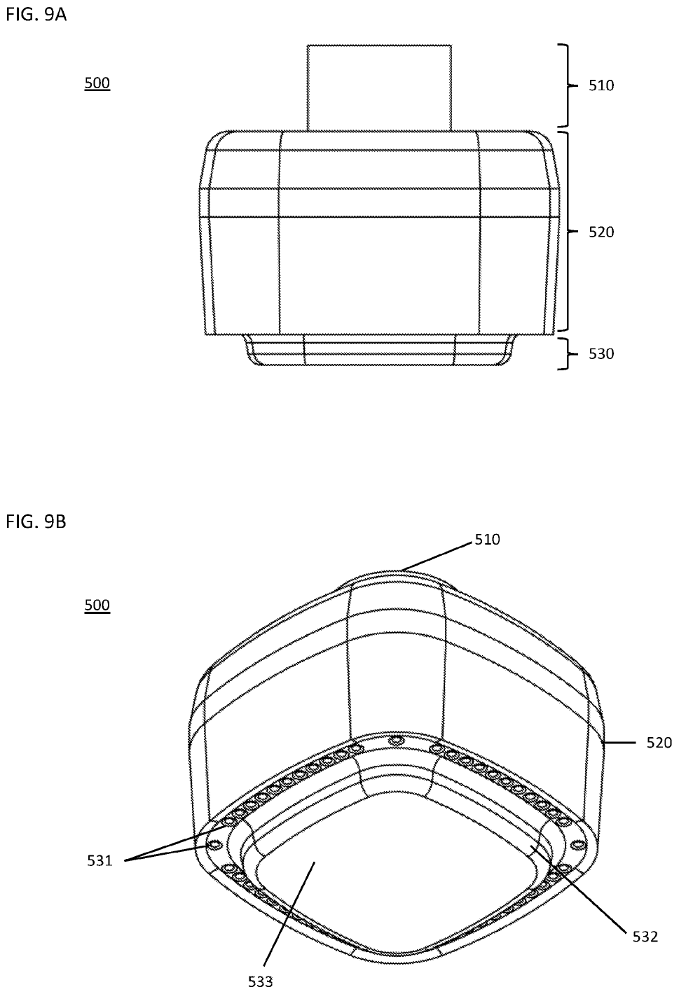

Referring to FIGS. 9A and 9B, baffle 500 moves on top of the open top end of the blank mold after a gob of glass is loaded into the blank mold cavity. Baffle 500 has arm 510, body 520 and foot 530. Foot 530 has ramp 532 and bottom end 533. A plurality of depressions 532 are circumferentially located on foot 530 which form stipples on the surface of the container base. In combination with a plunger, a mold and a neck ring, baffle 500 helps form the desired glass container and provides stippling on the bottom surface of the glass container. In some embodiments, a gas, such as compressed air, is added at the baffle side to push the gob of glass downward as the plunger moves in an upward direction. The counter force of the plunger and the compressed air aid in the gob to uniformly spread throughout the blank mold and neck ring.

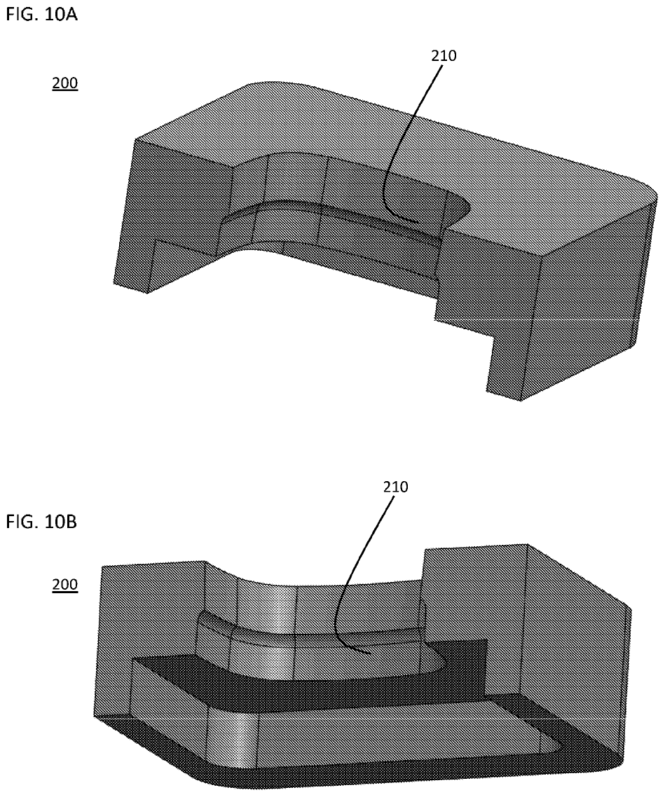

Referring to FIGS. 10A and 10B, mold 200 has halves 200A and 200B. Mold 200 defines blank mold cavity 210, which is sized and configured to receive a gob of glass. Mold 200 has an open bottom end for receiving a neck ring (e.g. neck ring 300), so that mold 200 and neck ring 300 are substantially flush. Mold 200 has an open top end. The open top end is sealed by a baffle during the glass manufacturing process.

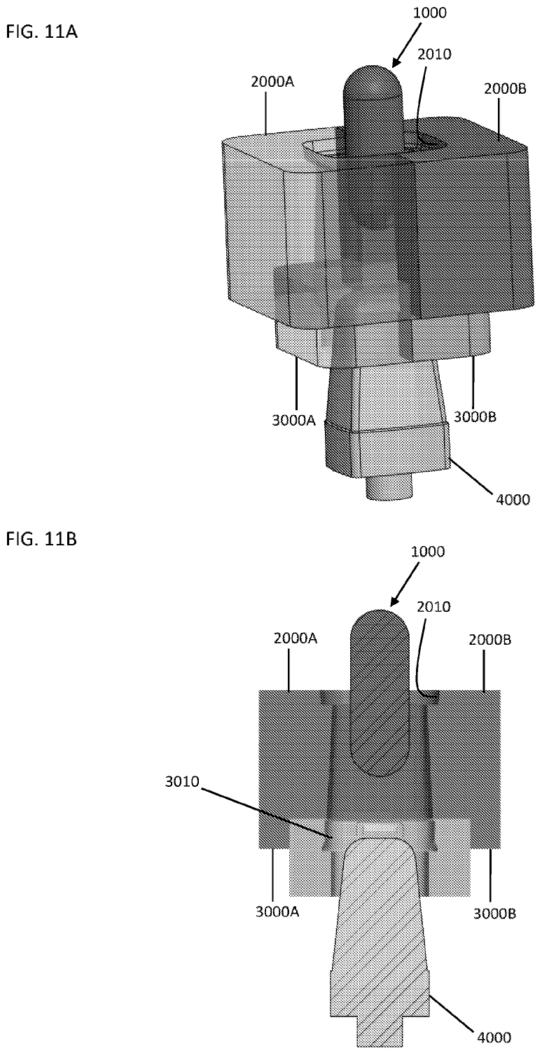

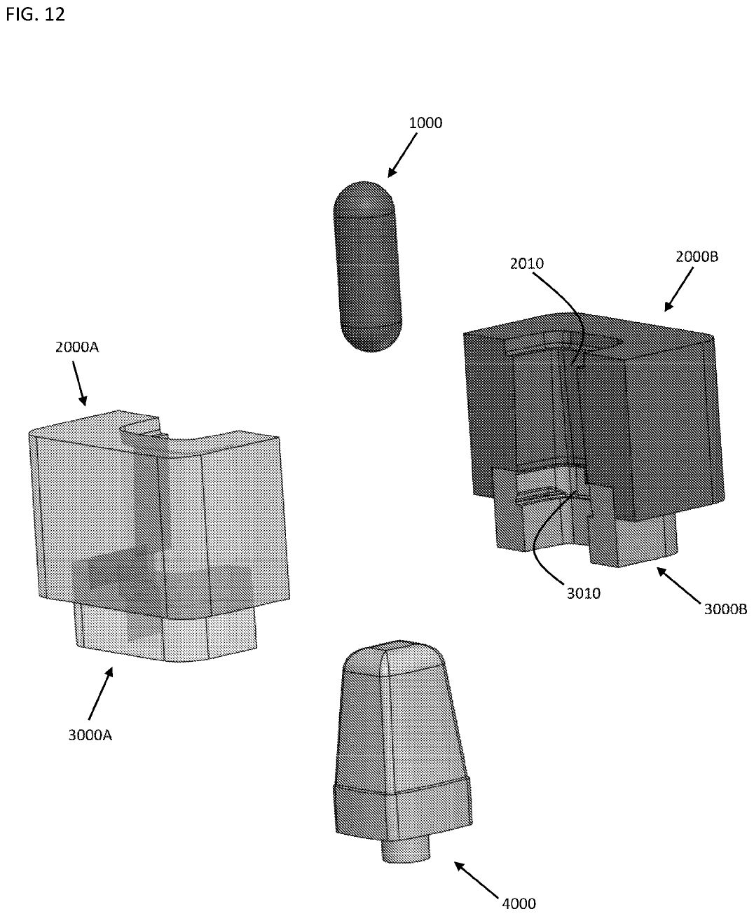

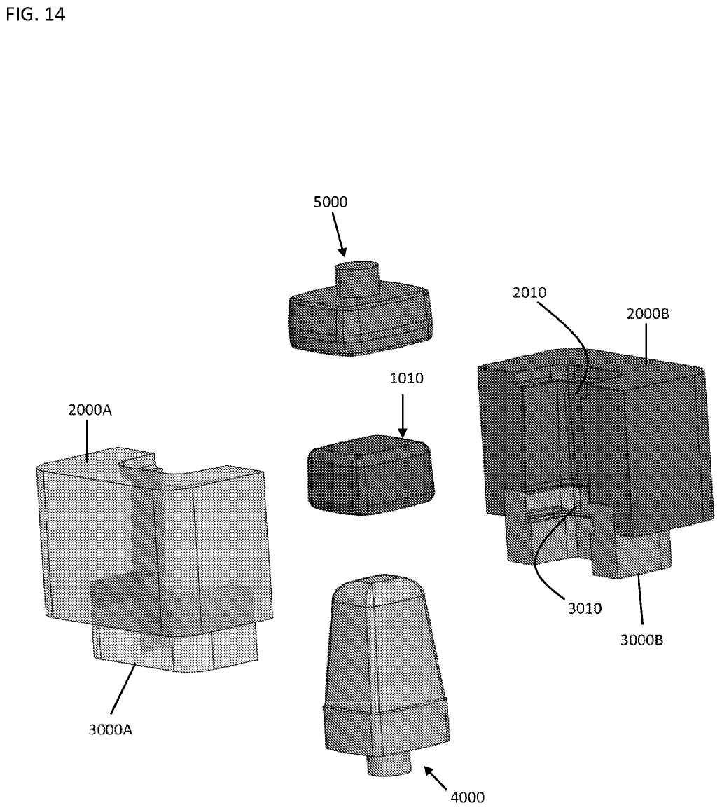

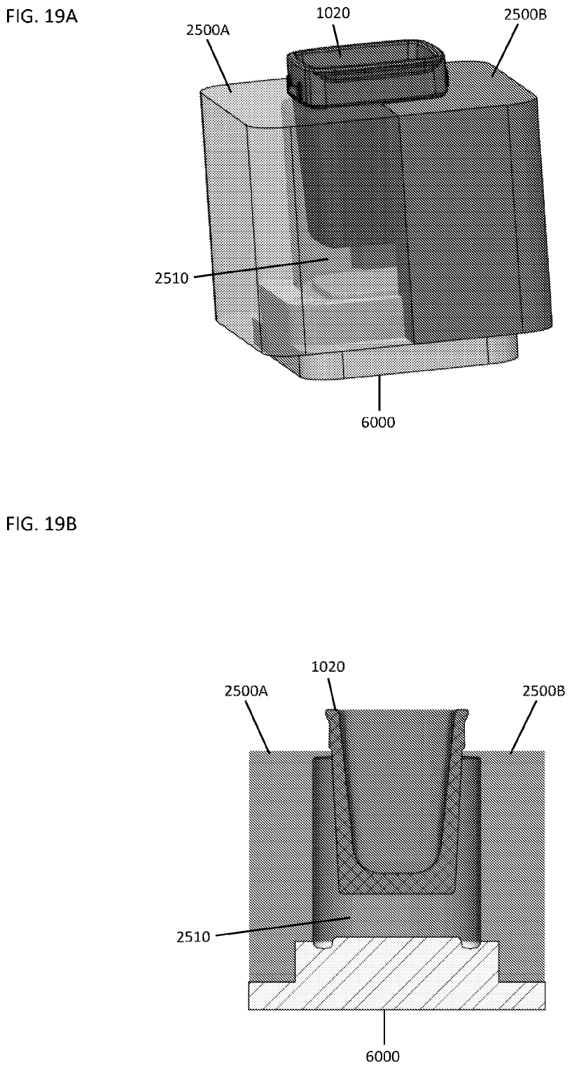

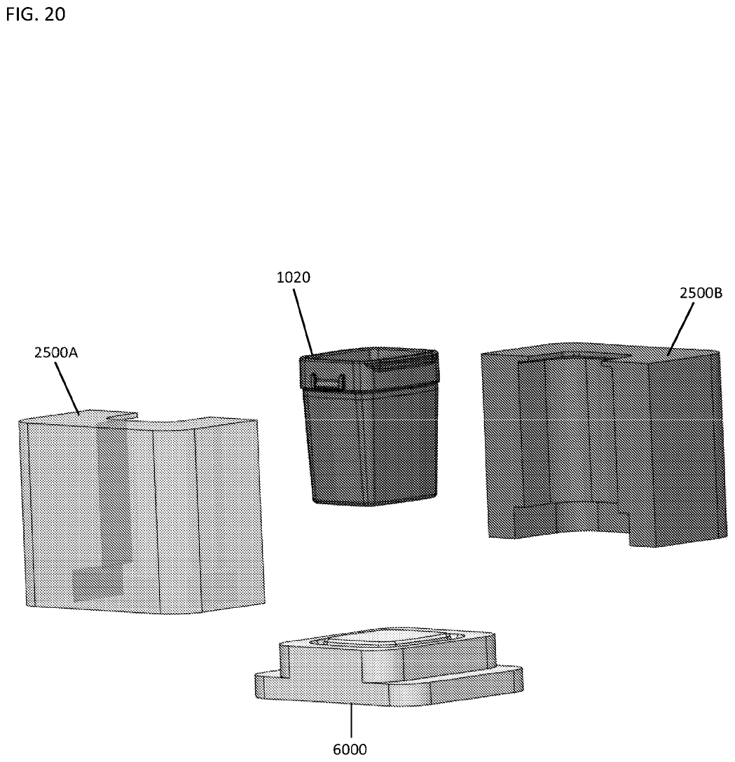

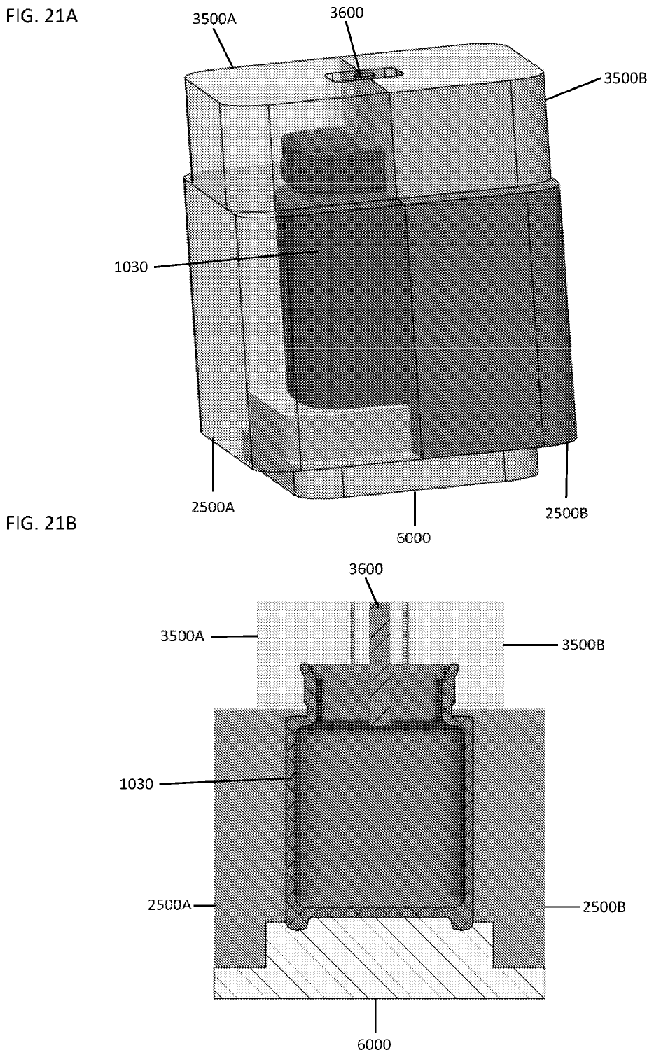

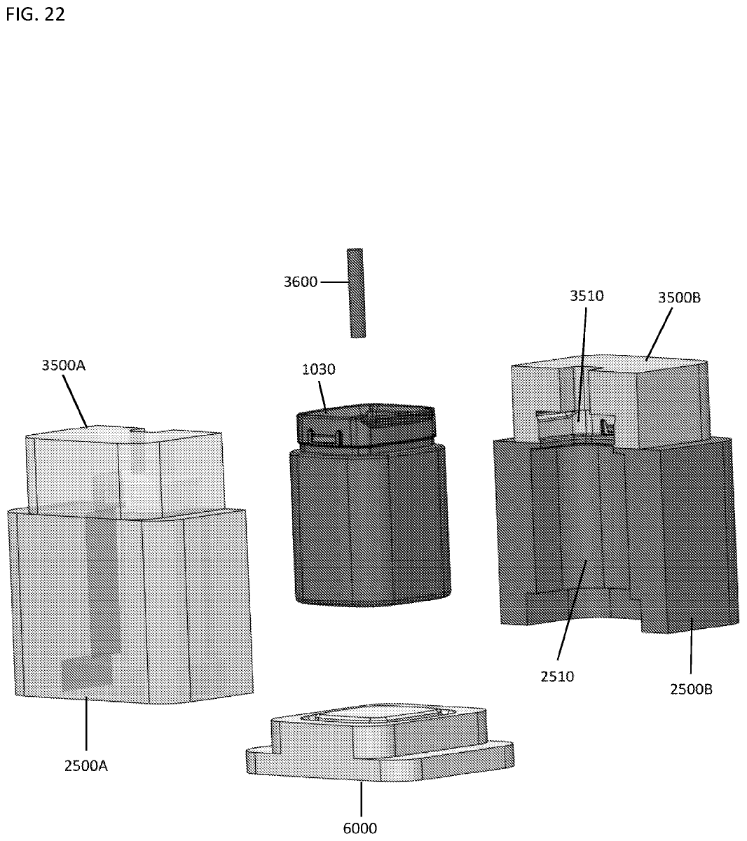

Referring to FIGS. 11-30D, components of an IS Machine and another method (i.e., press and blow) of manufacturing glass containers are illustrated. In the press and blow process, gob 1000 is guided into blank mold 2000 having two halves 2000A, 2000B, of which are clamped shut and then sealed by baffle 5000 at the open top end of the blank molds. The gob 1000 is formed into parison 1020 by plunger 4000, which presses the molten glass 1000, 1010 out to fill the blank mold 2000 and baffle 5000. The baffle 5000 is then removed, the blank mold 2000 opened, and the inverted parison 1020 is transferred to an upright position by neck rings 3000 where it is enclosed within blow mold 2500 by closing two blow mold halves 2500A, 2500B. The parison 1020 is then blown out (e.g., by compressed air) into the blow mold 2500 to form the final shape of the glass container 1030.

Gob of glass 1000 is fed into blank mold cavity 2010 and neck ring cavity 3010, defined by blank mold 2000 and by neck ring 3000, respectively. At a bottom end, plunger 4000 is moveable between a retracted position to an extended position. In a retracted position, plunger 4000 is completely or partially withdrawn from blank mold 2000 and/or neck ring 3000. This allows for gob 1000 to load into blank mold cavity 2100. In an extended position, plunger 4000 is moveable through and sits within neck ring 3000 and/or blank mold 2000.

Gob of glass 1000 has a predetermined mass, shape, or both. Gob 1000 is a discrete slug of glass sheared from a molten glass stream and matching the desired container weight. Gob 1000 is comprised of any glass (e.g., any non-crystalline, amorphous solid), any glass-like material (e.g., porcelain, thermoplastics), polymer glass, glass-ceramic, ceramic material, or combination thereof. For example, the glass can be an amber glass, a green glass, an opal glass, a transparent glass, recycled glass, flint glass, tempered glass, soda-lime glass, borosilicate glass, or others.

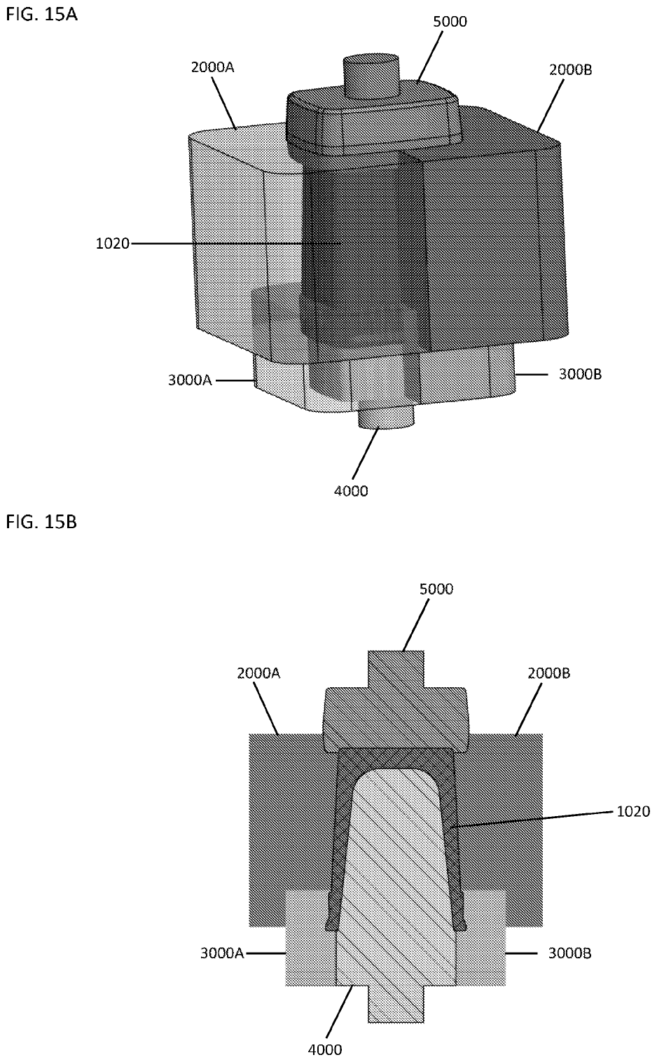

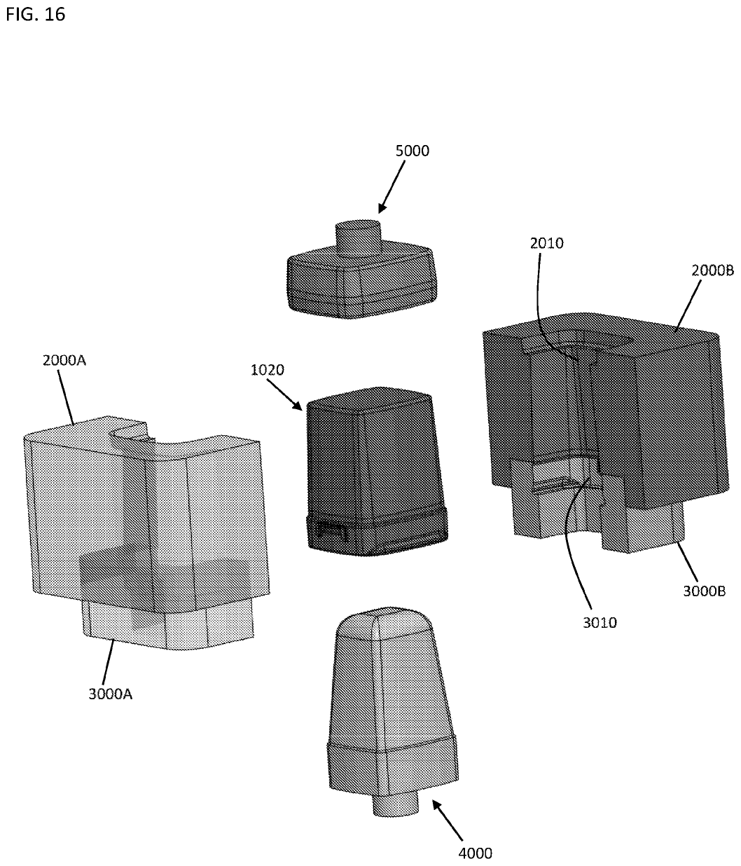

Blank mold 2000 is made up of two halves 2000A, 2000B. Blank mold 2000 defines blank mold cavity 2100, sized and configured to receive gob of glass 1000 and plunger 4000 to move between a retracted position and an extended position. Blank mold 2000 helps shape and form gob of glass 1000 into a parison (e.g., See FIGS. 15A, 15B and 16).

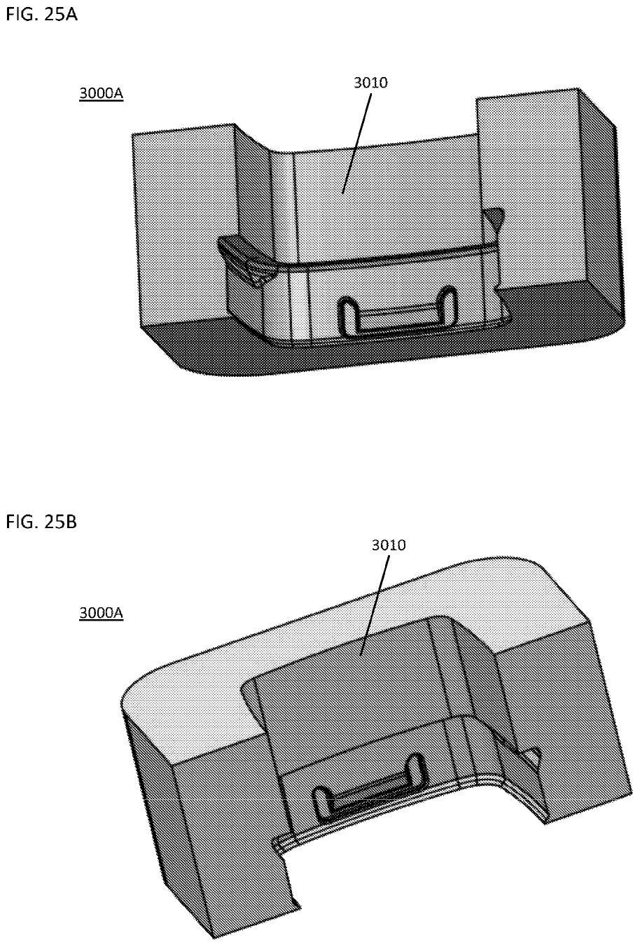

Neck ring 3000 is made up of two halves 3000A, 3000B (See FIGS. 25A-25B). Neck ring 3000 is sized and configured to sit directly beneath and align with blank mold 2000. Neck ring 3000 defines neck ring cavity 3100 and is sized and configured to receive gob of glass 1000 and plunger 4000 to move between a retracted position to an extended position.

Neck ring 3000 creates neck molding on the gob of glass, such as child-resistant features, threading, ridges, bumps, and other similar features. Neck ring 3000 is defined by halves 3000A and 3000B that combine and define a neck ring cavity 3010. In certain aspects, neck ring cavity defines a mold to form one or more retention features on the glass container during the manufacturing process. In certain aspects, the retention feature includes child-resistant features on the glass container (i.e., the neck of the container). Such child-resistant features are described and illustrated herein. For example, a child-resistant feature is formed on opposites sides of the glass container. In another example, a child-resistant feature is formed on one, two, three, four, five, fix, seven, eight or more sides of the glass container. The child-resistant feature includes a mechanism on the base for a container cap to mate with the container base providing a child-resistant container. In other aspects, neck ring cavity defines a mold to form any type of a cap retention feature, such as threading, rails, and the like.

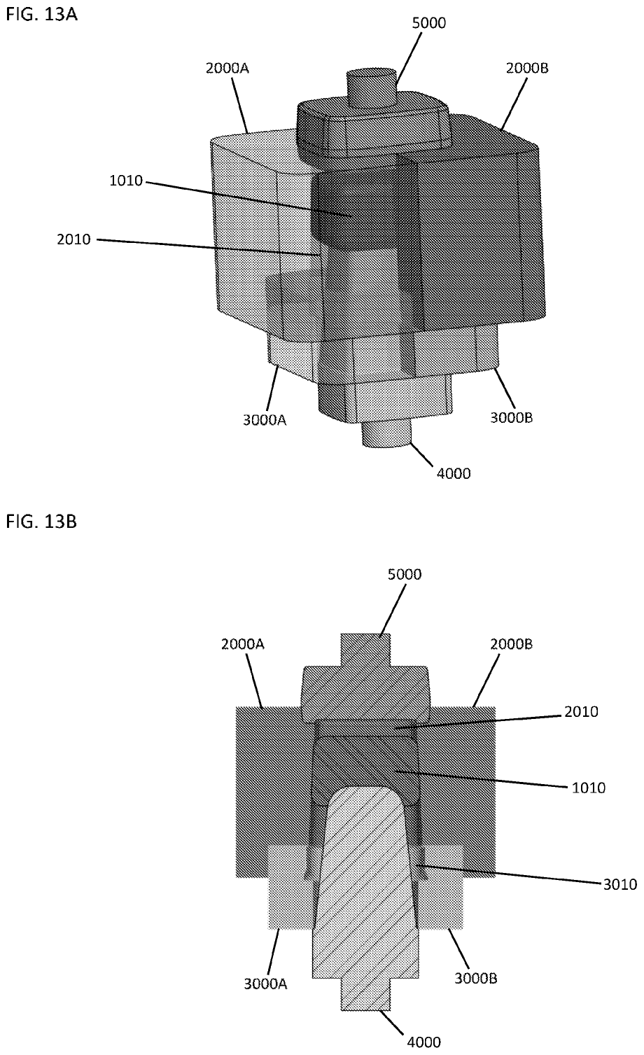

Gob of glass 1000 loads into blank mold cavity 2010. Baffle 5000 moves down to sit on top of and seals blank mold 2000, covering blank mold cavity 2010. Once gob 1000 is loaded, plunger 4000 starts to move up, from a retracted position to an extended position. Movement of plunger 4000 presses and displaces gob of glass 1000 outwardly to the inner walls of blank mold 2000 and neck mold 3000 (See FIGS. 13A and 13B). In some aspects, a gas (e.g., compressed air) can be blown down from baffle 5000 to aid in the formation of parison 1020. Gob of glass 1010 (FIGS. 13A and 13B) substantially conforms to cavities 2010, 3010, defined by blank mold 2000, neck ring 3000, baffle 5000 and, in some embodiments, compressed air from the baffle side, caused by the movement of plunger 4000. Plunger 4000 continues to move through neck ring 3000 into blank mold 2000. In an extended position, plunger presses glass 1010 to form parison 1020 (FIGS. 15A, 15B). Parison 1020 is a partially-formed container base, with generally defined geometries, such as having rounded corners.

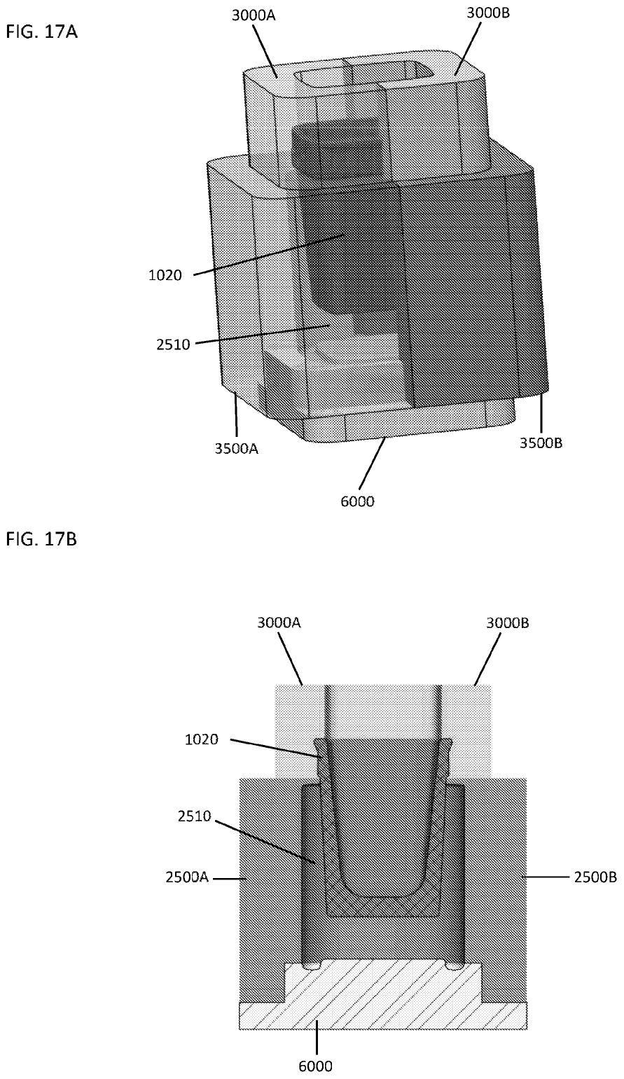

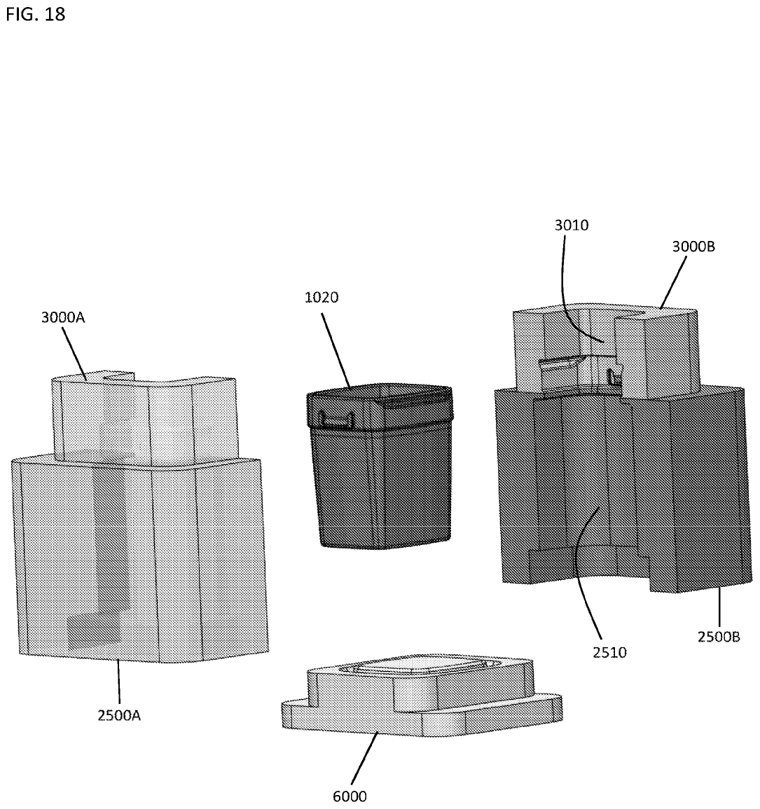

Once parison 1020 is formed and referring to FIG. 17A and 17B, baffle 5000 moves off the blank mold 2000. Blank mold 2000 opens and parison 1020 is inverted to the blow side. Blow mold 3500 moves around parison 1020. Blow mold 3500 sits between bottom plate 6000 and neck ring 3000. Referring to FIGS. 18A and 18B, neck ring 3000 opens and blowhead 3500 moves onto blow mold 2500. Blowhead 3500 is used to direct gas (e.g., compressed air) into parison 1020, which expands and shapes parison 1020 to the inner walls of blow mold 2500. In some embodiments, blow-tube 3600 can be added and used to direct gas (e.g., compressed air) into parison 1020, which expands and shapes parison 1020 to the inner walls of blow mold 2500. Container 1030 is formed from the final “blow” step.

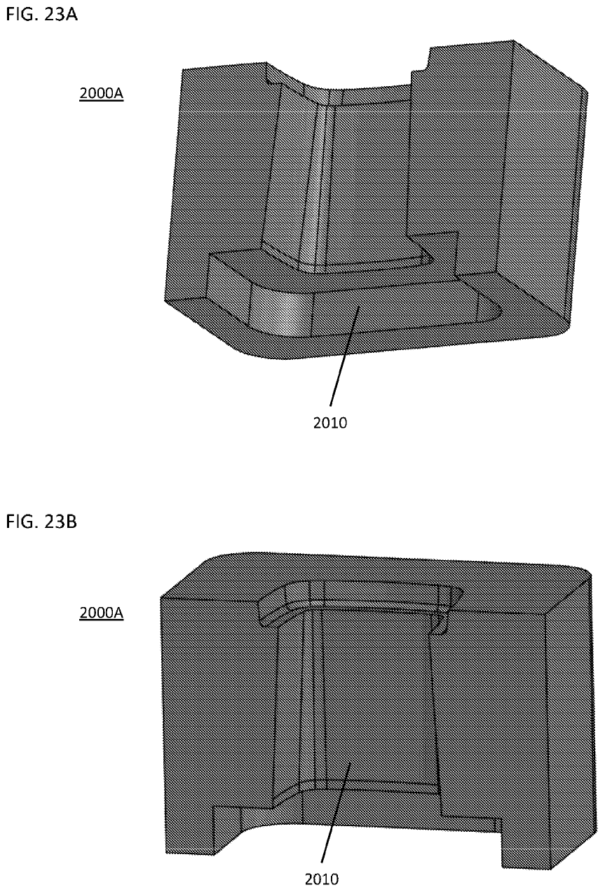

Referring to FIGS. 23A and 23B, blank mold 2000 has two halves 2000A and 2000B. Blank mold 2000 defines blank mold cavity 2010, which is sized and configured to receive a gob of glass. Blank mold 2000 also defines a cavity for a neck ring (e.g. neck ring 3000) to sit, so that blank mold 2000 and neck ring 3000 are substantially flush.

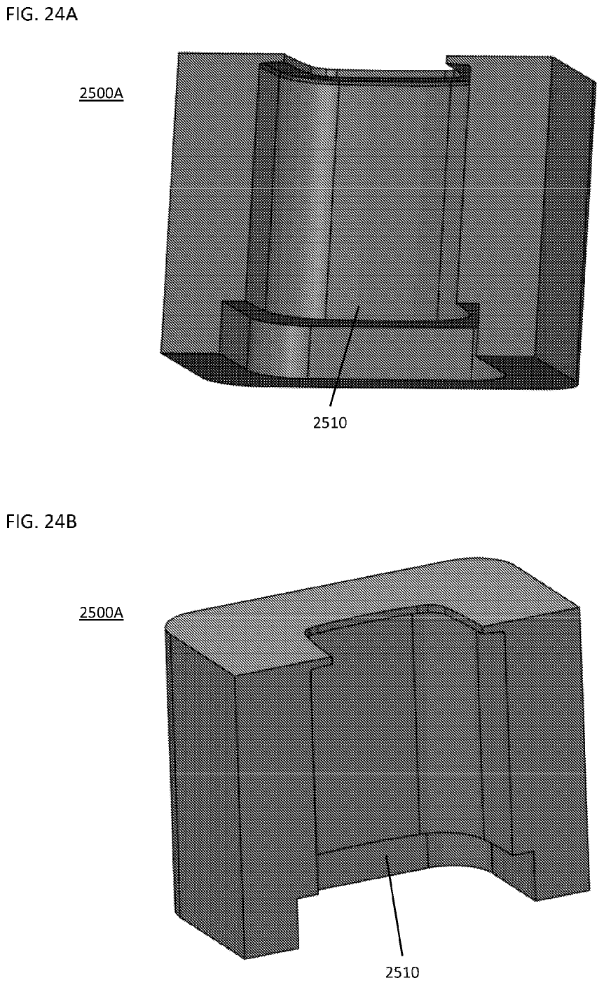

Referring to FIGS. 24A and 24B, blow mold 2500 has two halves 2500A and 2500B. Blow mold 2500 defines a blow mold cavity, which is sized and configured to receive a parison and form the final container. Blow mold 2500 is configured to fit with a neck ring and a blowhead during the glass manufacturing process.

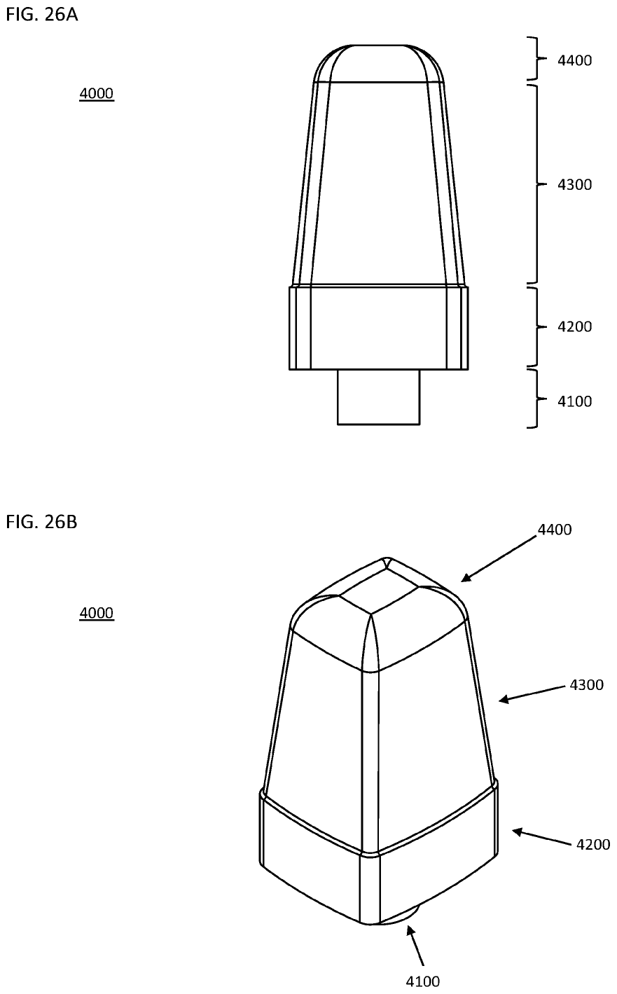

Referring to FIGS. 26A and 26B, plunger 4000 has shaft 4100, lower section 4200, middle section 4300 and upper portion 4400. Middle section 4300 and upper section 4400 are shaped and sized to substantially form a cavity of the parison (e.g., parison 1020). Lower section 4200 has a substantially rectangular cross-sectional shape and is generally square with rounded corners. Lower section 4200 extends to middle section 4300, which expends to upper section 4400. Upper section 4400 tapers to a terminal end of plunger 4000. The parison formed by plunger 4000 substantially correlates to the size and shape of plunger 4000. Substantially square geometries are produced by the components and methods described herein, but also polyhedron, prism and other related three-dimensional geometries are produced.

Plungers used for the press and blow process can have other geometries that would still produce the glass containers described herein. Substantially round, round (e.g., cylindrical), oval and other non-polygonal shaped plungers can be used in the press step to form the parison. The final blow step expands the parison to form its desired shape.

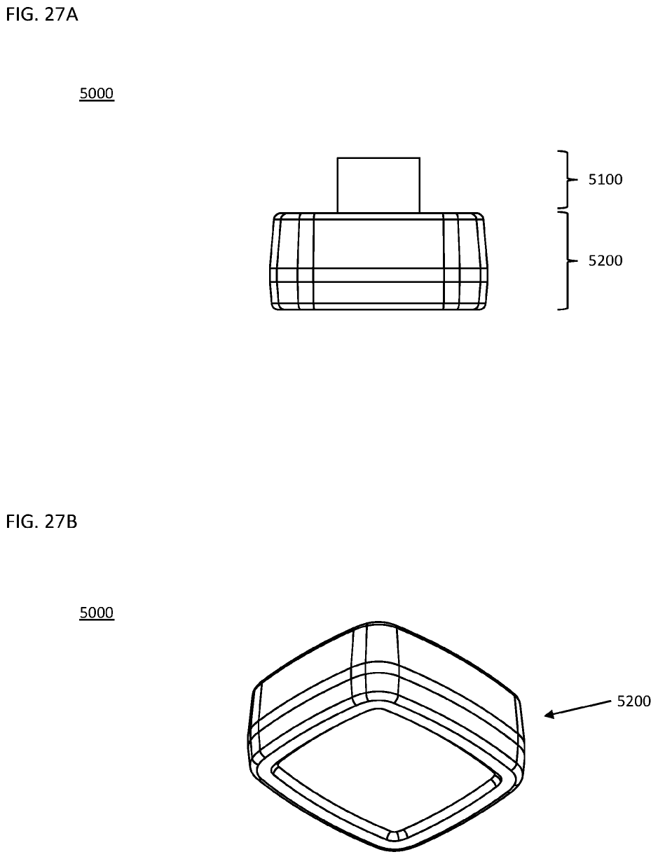

Referring to FIGS. 27A and 27B, baffle 5000 moves on top of blank mold after a gob of glass is loaded into the blank mold cavity. Baffle 5000 has arm 5100 and body 5200.

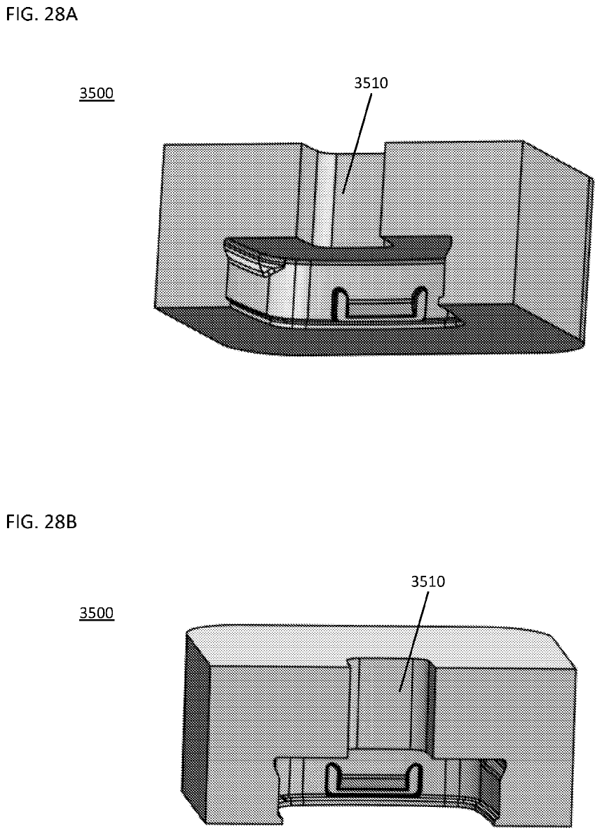

Referring to FIGS. 28A and 28B, blowhead 3500 defines blowhead cavity 3510. A neck of a parison can be secured by blowhead to direct gas, such as compressed air, into the parison. In some embodiments, the gas is directed through a blow tube.

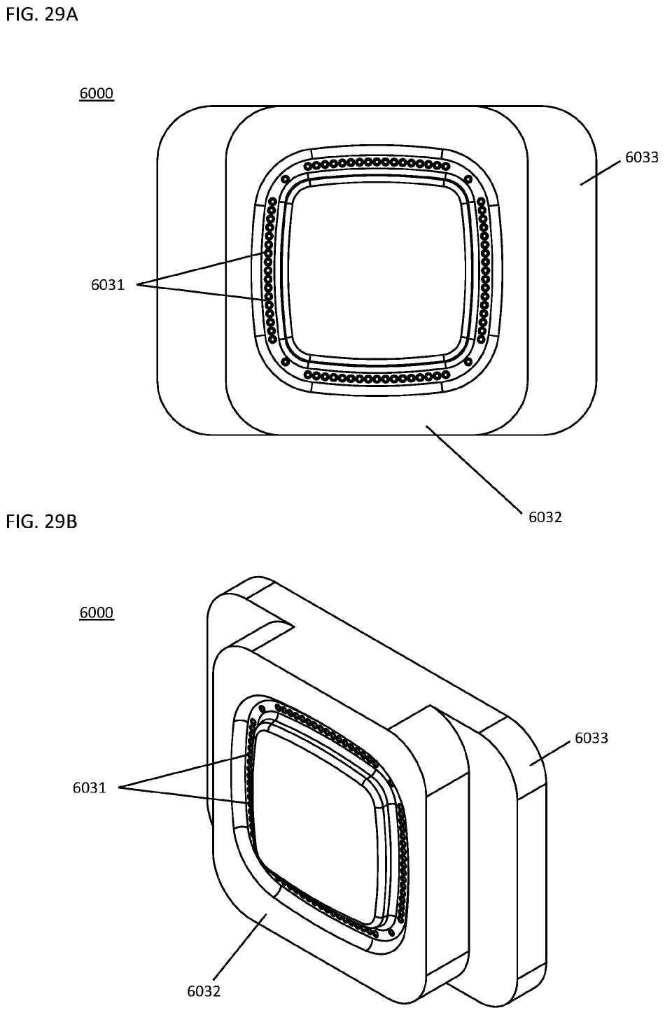

Referring to FIGS. 29A and 29B, bottom plate 600 has an outer base 6033 and top base 6032. Depressions 6031 form stipples on the surface of the container base during the “blow” step. In combination with a blow mold and blowhead, bottom plate 6000 helps form the desired glass container and provides stippling on the bottom surface of the glass container.

A child-resistant feature of the container relates to the engagement of the container base (e.g., base 1030) with the container cap. As shown and described herein, one or more cap engagement mechanisms are part of the container base 110, 1030. A cap engagement mechanism is made up of a pair of ramps and a ridge. The cap engagement mechanism is in a “U” or “H” shape or another configuration, such as, for example, an “I,” “⊥,” “-,” or any other configuration of the ramps and ridge. The ramps extend from at or near the open end of a cap to or near the transfer neck or foot/support portion of the container base. A ridge is formed between two ramps. The ramps and ridge provide guidance and alignment of the container cap in addition to providing a tight fit with the container base. The cap engagement mechanism prevents a container cap from easily being taken off the container base or removed improperly. Generally, a cap engagement mechanism is position on two, opposite sides of the container base. However, other configurations of the cap engagement mechanisms are contemplated, such as 1, 3 or 4 cap engagement mechanisms on the container base.

The sizes and shapes of the disclosed glass manufacturing components define and produce the desired glass container. The blank mold, neck ring, plunger, baffle, blow mold, and blowhead all contribute to and define the desired shape of the glass container. Generally, substantially square-shaped containers having a square-shaped neck are manufactured using the components described herein. Also, any polygonal-shaped container may be manufactured as described herein. The container and the neck, for example, may be generally square, rectangular, diamond, quadrilateral, or rhomboid in shape. In some aspects, the container and the neck are substantially square, square, and/or square with rounded edges.

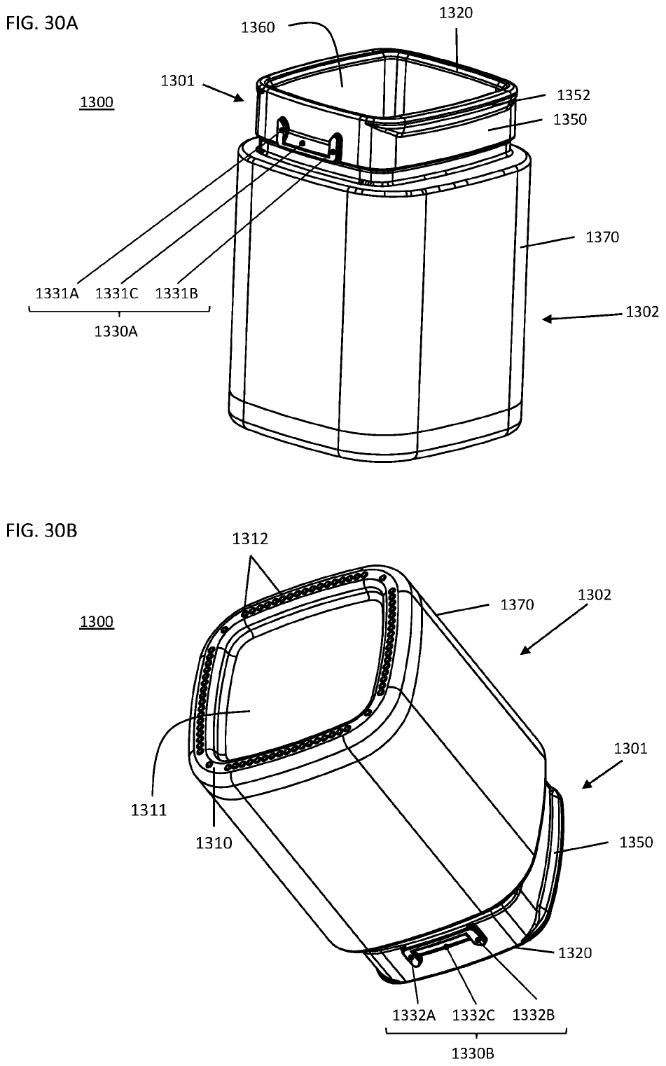

For example, container 1300 (FIGS. 30A-30D) is produced using the glass manufacturing methods and components described herein. Container base 1300 has neck 1301 and foot/support 1302. Container base 1300, having neck 1301 and foot 1302, is substantially square with rounded corners. Container base 1300 has an open top end 1320 and a closed bottom end 1310. Closed bottom end 1310 has stipples 1312 and a recessed potion 1311, sized and configured to receive a container cap (e.g., to allow for stacking). One or more cap engagement mechanisms 1330A, 1330B are positioned on one or more sides 1350 of container base 1300. One or more sides 1350 have lip 1352 near or at the open top end 1320 of the container base 1300. Lip 1352 helps with alignment of a cap onto container base 1300 and provides additional support and stability of the cap while on base 1300.

Cap engagement mechanism 1330A on one side of the container base 1300 has ramps 1331A and 1331B. Ridge 1331C is disposed between ramps 1331A and 1331B. Cap engagement mechanism 1330B on one side of the container base 1300 has ramps 1332A and 1332B. Ridge 1332C is disposed between ramps 1332A and 1332B.

Ramps 1331A, 1331B and ridge 1331C generally form a “U” shaped cap engagement mechanism 1330A. Similarly, ramps 1332A, 1332B and ridge 1332C generally form a “U” shaped cap engagement mechanism 1330B. Ramps 1331A, 1331B and 1332A, 1332B extend near or from the open top end 1320 to or near the transfer neck 1351.

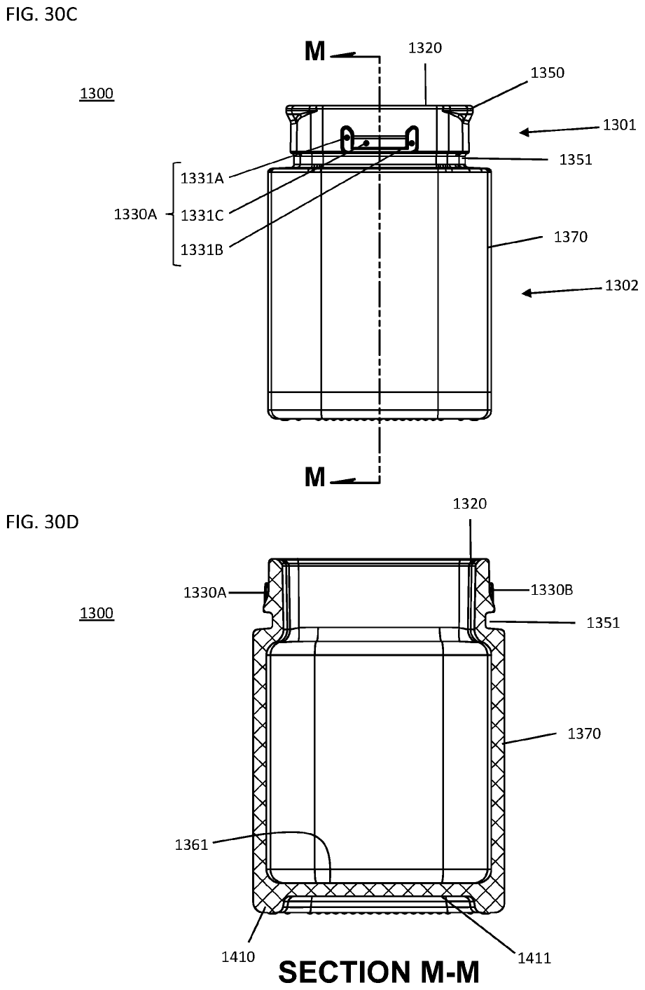

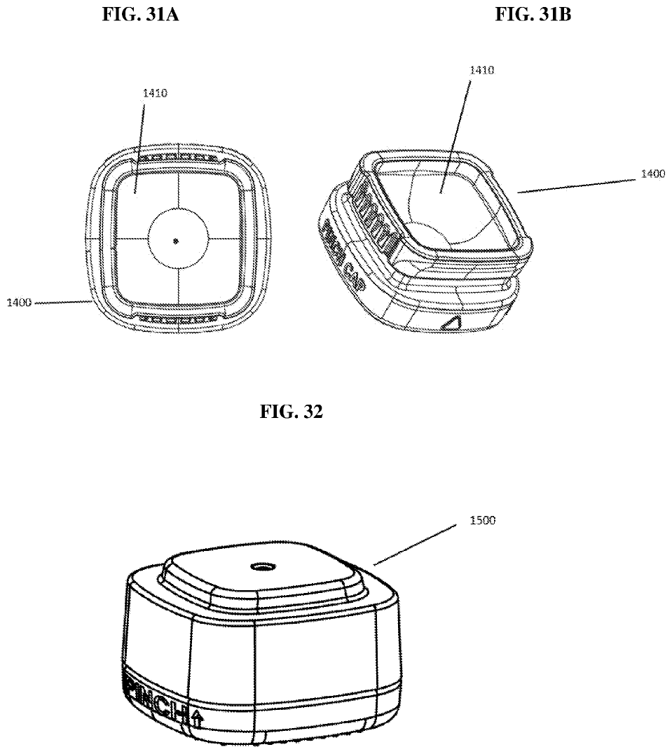

In FIGS. 31A and 31B, a further preferred glass container base 1400 is depicted with open end 4010. FIG. 32 depicts a preferred exemplary cap unit 1500 that can releasably engage with container base 1400.

Parts of IS Machine

Variables—Hold and support the mold equipment

Mechanism—Moves the variables that hold and support the mold equipment

Mold Holder: to hold the molds; come in various sizes in regards to machine center distance (e.g., 4¼, 5, 5½, 6¼, 8½); single gob, double gobs, triple gobs.

Blank Holder: to hold the blanks; comes in various sizes in regards to machine center distance (e.g., 4¼, 5, 5½, 6¼, 8½); single gob, double gobs, triple gobs

Blow & Blow Cartridge: to hold and support the blow & blow plunger and thimble; assist counter blow to pass through the plunger

Press & Blow Cartridge: to hold and support the press and blow plunger; hold the plunger spacer and loading screw

Press & Blow Adaptor, Collar & Spacer: adaptor and collar hold the plunger in position; the spacer restricts the plunger down stroke in order has clearance to invert, but only enough to have clearance of the neck ring

Take Out Arm: to hold the bottle from the bottom plate to the dead plate

Funnel Arm: to carry the funnel onto the top of the blank

Baffle Arm: to hold and support the baffle; allows that settle blow to pass through to the baffle

Blow Head Arm: to hold and support the blowhead; allows the final blow and finish cooling to pass through to the blowhead

Neck Ring Arm: to hold and support the neck ring; transfer parison from the blank size to mold size

Distributor Plate: to hold and support the bottom plate; allows the vertiflow cooling to pass through to the bottom plate

Plunger Mechanism: to move the parts of cartridge up and down; assist counter blow to pass through to the plunger/plunger cooling. It is made up of 3 main parts: (i) base plate to which oil and air connects to lubricates the cylinder and shaft which move up and down; (ii) the upper cylinder holds the cartridge and the lower part holds the piston and shaft; and (iii) guild plate which is used to align the plunger cylinder to the blank

Blowhead Mechanism: to hold the blowhead arm and move the blowhead arm on and off to the top of the mold

Funnel Mechanism: to hold the funnel arm and move it on and off to the top of the blank

Baffle Mechanism: to hold the baffle arm and move it on and off to the top of funnel for settle blow pass through, and bring the baffle arm on and off to the top of the blank

Neck Ring Mechanism: to hold the neck ring arm, also opens and closes the neck ring

Invert Mechanism: to move the neck ring arm from blank side to mold side and back) (180°).

Vertiflow Mechanism: (type of bottom plate mechanism); to supply cooling to the mold and has the ability to shut the hold cooling wind on and off. Also has the ability to pass vacuum (if used); raise or lower the bottom plate as needed.

Wiper Mechanism: to hold the 90° pusher and move to dead plate to the front/long conveyor.

Take out Mechanism: to move the take out arm from the mold bottom plate to the dead plate.

Glass Containers

The glass containers produced by the disclosure provided herein are described in U.S. Provisional Patent Application 62/802,381, filed Feb. 7, 2019, and U.S. Provisional Application 62/825,976, filed Mar. 29, 2019, their contents are hereby incorporated by reference in its entirety. The glass containers can be made of glass (e.g., any non-crystalline, amorphous solid), any glass-like material (e.g., porcelain, thermoplastics), polymer glass, glass-ceramic, ceramic material, or combination thereof. Examples of suitable glass used to construct the container base includes but is not limited to, an amber glass, a green glass, an opal glass, a transparent glass, recycled glass, flint glass, tempered glass, soda-lime glass, borosilicate glass, or others. The glass can be colored, patterned, textured, clear, and/or opaque.

For example, a child-resistant glass container base having a closed bottom end, an open top end, and sides that define a cavity. On certain sides of the glass container base are cap engagement mechanisms. Cap engagement mechanism is made up of ramps and a ridge. Cap engagement element is a retention feature that provides child-resistance such that a container cap snaps or locks into place with the container base.

Due to the shape and dimension of the plunger, molds, or a combination, the sides of the glass container are slightly convex (e.g., curved) but form a substantially square shape. The edges between each of sides are curved but can also be at right (90°) angles to each other.

Manufactured glass container bases also have a transfer neck around the entire circumference of the container base. The transfer neck allows machinery to move the container base during glass manufacturing.

The glass container has a generally unitary structure and has a neck that sits on a support or foot. Cap engagement element is positioned on side and on the neck portion of container base.

The glass containers manufactured by the methods and the components described herein also have a closed bottom end with a recessed portion. The recessed portion is sized and configured to receive a top end of a container cap to allow for containers to stack upon each other.

The glass containers produced have a storage volume of about 1 ml to about 2000 ml, about 2 ml to about 1000 ml, about 3 ml to about 500 ml, about 4 ml to about 100 ml, about 5 ml to about 50 ml, or about 5 ml to about 10 ml. In some aspects, the volume of the container is about 1 ml, 2 ml, 3 ml, 4 ml, 5 ml, 6 ml, 7 ml, 8 ml, 9 ml, 10 ml, 11 ml, 12 ml, 13 ml, 14 ml, 15 ml, 16 ml, 17 ml, 18 ml, 19 ml, 20 ml, 25 ml, 30 ml, 40 ml, 50 ml, 60 ml, 70 ml, 80 ml, 90 ml, 100 ml, 150 ml, 200 ml, 250 ml, 300 ml, 350 ml, 400 ml, 450 ml, 500 ml, 600 ml, 700 ml, 750 ml, 1000 ml, 1250 ml, 1500 ml, or 2000 ml. In some aspects, the storage volume of the manufactured container is less than 1 ml or greater than 2000 ml. In some aspects, the volume of the container is about 5 dram, 10 dram, 15 dram, 20 dram, 25 dram, 30 dram, 40 dram, 45 dram, 50 dram, 60 dram, 70 dram, 80 dram 90 dram, 100 dram, 110 dram, 120 dram, 125 dram, 130 dram, 135 dram, 140 dram or 145 dram. In other aspects, the volume of the container is less than 15 dram or greater than 145 dram.

The manufactured child-resistant glass containers are stackable. That is, one glass container can be stacked on top of another glass container having a container cap. The elevated portion of a container cap from one container is configured to sit inside of a recessed portion of container base. The child-resistant glass containers have configurations to allow for self-stacking.

The child-resistant features of the container relate to the engagement of the glass container with a container cap. One or more cap engagement mechanisms are part of the container base. The cap engagement mechanism is made up of a pair of ramps and a ridge. The ramps extend from at or near the open end of a cap to or near the transfer neck or foot/support portion of the container base. A ridge is between two ramps. The ramps and ridge provide guidance and alignment of the container cap in addition to providing a tight fit with the container base. The cap engagement mechanism prevents a container cap from easily being taken off the container base or removed improperly. Generally, a cap engagement mechanism is position on two, opposite sides of the container base. However, other configurations of the cap engagement mechanisms are contemplated, such as 1, 3 or 4 mechanisms on the container base.

The container cap is configured to associate with the container base. The container base form an enclosure for containing materials, and the container cap encloses the open top end of the base.

The disclosure provides a method of manufacturing a child resistant glass container. The method involves moving a plunger from a retracted position to an extended position within a mold cavity defined by at least one blank mold, wherein said moving introduces the plunger into a predetermined amount of gob of molten glass in the mold cavity; forming a parison from the predetermined amount of gob in the mold cavity; retracting the plunger from the extended position to the retracted position; and applying compressed gas through a neck of the parison to expand the parison to a substantially square glass container shape; and separating the substantially square glass container from the one or more blank mold.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A component for forming a glass container comprising:
a blank mold comprising an opening at an upper end for receiving a gob of molten glass and an opening at a lower end for receiving a neck ring, wherein the blank mold defines a blank mold cavity;
a plunger adjacent to the lower end the blank mold, and moveable between a retracted position out of the blank mold and an extended position in the mold cavity; and
a blow mold defining a blow mold cavity and configured to receive a parison;
wherein the blank mold cavity, the plunger, the blow mold cavity, or a combination thereof is substantially square in cross-sectional shape.

2. The component of claim 1, wherein the blank mold, the plunger, the blow mold, or a combination thereof are configured to produce a substantially square shaped container.

3. The component of claim 2, wherein the substantially square shaped container has rounded corners.

4. The component of claim 3, wherein neck ring is substantially square in cross-sectional shape and configured to produce a substantially square container neck.

5. The component of claim 4, wherein the neck ring is configured to produce a retention feature on the neck of the container.

6. The component of claim 5, wherein the retention feature is a child-resistant feature.

7. The component of claim 6, wherein the child-resistant feature is produced on a first side of the container and a second side of the container.

8. The component of claim 6, wherein the component is configured to form a glass container having a storage volume of 1 ml to 2000 ml.

9. The component of claim 8, wherein the storage volume is 4 ml to 100 ml.

10. The component of claim 1, wherein the component is part of an Individual Section machine.

11. A method of manufacturing a glass container comprising:
introducing a predetermined amount of a gob of glass to a blank mold cavity defined by a blank mold;
moving a substantially square-shaped plunger from a retracted position to an extended position within the blank mold cavity;
forming a parison by the plunger from the predetermined amount of gob in the mold cavity;
retracting the plunger out from the blank mold cavity to the retracted position;
moving the parison from the blank mold to a blow mold;
applying a compressed gas through a neck of the parison to expand the parison to a substantially square glass container shape defined by a blow mold; and
separating the substantially square glass container from the blow mold.

12. The method of claim 11, wherein the glass container includes a retention feature on the neck of the glass container.

13. The method of claim 12, wherein the retention feature is a child-resistant feature.

14. The method of claim 13, wherein the child-resistant feature is on one or more sides of the neck of the glass container.

15. The method of claim 14, wherein the child-resistant feature is on opposite sides of the neck of the glass container.

16. The method of claim 11, wherein the glass container is manufactured at a rate of about fifty (50) to about nine hundred (900) containers per minute.

17. The method of claim 16, wherein the glass container is manufactured at a rate of about one hundred (100) to about five hundred (500) containers per minute.

18. A method of manufacturing a glass container comprising:
introducing a predetermined amount of a gob of glass to a blank mold cavity defined by a mold;
moving a plunger from a retracted position to an extended position through a neck ring and within the mold cavity;
forming a substantially square glass container shape defined by the neck ring and mold; and
separating the substantially square glass container having a substantially square neck from the neck ring and mold.

19. The method of claim 18, wherein the neck ring forms one or more retention features on the neck of the substantially square glass container.

20. The method of claim 19, wherein each of the one or more retention features comprises a child-resistant feature.
